(19) United States
(12) Patent Application Publication
(10) Pub. No.: US 2026/0271919 A1
(43) Pub. Date: Sep. 17, 2026

(54) Emulsifiable Concentrate for Environmentally Friendly and High Efficacy Agricultural Applications

(71) Applicant: KATA CIRCULAR PTE. LTD., Singapore (SG)

(72) Inventors: Fernando R. de Tezanos, Guatemala City (GT); Matias R. de Tezanos, Guatemala City (GT)

(21) Appl. No.: 19/263,210

(22) Filed: Jul. 8, 2025

Related U.S. Application Data
(63) Continuation-in-part of application No. 19/078,913, filed on Mar. 13, 2025.

(51) Int. Cl. A01N 25/06; A01N 43/54; A01N 43/653; A01P 3/00; A01P 7/04

(52) U.S. Cl. CPC A01N 25/06; A01N 43/54; A01N 43/653; A01P 3/00; A01P 7/04

(57) ABSTRACT

An emulsifiable concentrate for environmentally friendly and high-efficacy agricultural applications and related sprayable treatment preparation methods utilizing specific dilution ratios and application protocols to achieve enhanced crop protection with reduced chemical loading. The concentrate preparation involves sonic emulsification of isoparaffinic oils with surfactant systems to create stable nano-emulsions that enable superior sprayable treatment formulations when combined with water and agricultural actives in predetermined ratios. Implementation of controlled application timing protocols during specific crop growth stages enables achievement of enhanced bioavailability and pest control efficacy while maintaining formulation stability across varying field conditions. The resultant sprayable compositions demonstrate superior adherence characteristics and extended retention periods despite utilizing significantly reduced surfactant content compared to conventional agricultural emulsions. Field application methods incorporating environmental parameters and phenological timing windows produce measurable crop yield improvements while reducing active ingredient requirements per hectare and application frequency through optimized delivery mechanisms and enhanced biological activity thresholds.

### CROSS-REFERENCE TO RELATED APPLICATIONS

This application claims the priority data of and is a continuation-in-part of U.S. application Ser. No. 19/078,913, filed on Mar. 13, 2025, which is hereby incorporated by reference herein in its entirety, including all appendices and attachments cited herein, for all purposes.

### FIELD

This disclosure pertains to the field of agricultural sprayable treatment formulations and application methods utilizing sonically-processed emulsifiable concentrates in specific dilution ratios and timing protocols to achieve enhanced crop protection efficacy with reduced active ingredient loading and improved adherence characteristics compared to conventional agricultural spray treatments.

### BACKGROUND

As global food demand increases with population growth, agriculture faces mounting pressure to improve productivity and ensure crop safety. Among the critical challenges are pests and diseases that can significantly impair or destroy crop yields. Various protective technologies have emerged, with mineral oil spraying being a widely adopted approach. Saturated paraffinic oils are particularly valuable due to their low polarity, which minimizes plant interaction while providing insecticidal and fungistatic properties through surface film formation. The effectiveness of these oils (often referred to as oil adjuvants or sticker oils) depends directly on surface area coverage, making smaller droplet sizes desirable for enhanced protection.

However, pure mineral oil applications carry prohibitive costs for agricultural use. The industry has adapted by utilizing emulsions combining mineral oil with water and emulsifiers. This approach not only reduces costs but also enables incorporation of additional agricultural agents in the aqueous phase. Current emulsion technologies face limitations in stability, coverage effectiveness, and environmental impact.

The use of oils for crop protection dates back to the 18th century. Agricultural spray oils are widely used in modern agriculture and there exists extensive knowledge regarding preparation of such products. Petroleum oil along with a variety of emulsifiers and their combinations have been used to manufacture the spray oils for agricultural applications. For instance, U.S. Pat. No. 3,982,920 describes soluble oil preparations that can form stable emulsions with water by gentle shaking. U.S. Pat. No. 4,531,965 discloses a weed control composition containing a mineral oil and adjuvant such as an emulsifier. U.S. Pat. No. 4,440,561 describes the use of white mineral oils in such products. U.S. Pat. Nos. 6,515,031 and 6,673,360 describe technique for emulsifying highly saturated hydroisomerized hydrocarbons using an emulsifier blend that includes ethoxylated C10-C16 alcohols having at least 2.8 ethoxy groups per chain and a glycerol mono- and/or dioleates, preferably in a ratio of from 9:1 to 4:6. These emulsion blends are claimed to be particularly useful when mixed with hydroisomerized oils and water, for subsequent application as a spray oil to agricultural crops. EP1883297 describes preparation of an agricultural spray oil by emulsifying hydroprocessed highly paraffinic oil using C16-C18 alcohol polyglycol ethers as emulsifiers. The preparation is claimed to have good emulsion stability in varying hardness of water, is eco-friendly and highly bio-degradable, non-toxic to humans and non-phytotoxic to plants, and at the same time is highly efficient in controlling plant diseases.

Oil-in-water emulsion-based products are ubiquitous in food, cosmetics, pharmaceuticals, metalworking, and agricultural chemicals. Various emulsion systems are widely applied in the industry. For instance, high pressure emulsifiers allow very small particle sizes to be obtained, namely of the order of 200 nm or even less. High intensity ultrasound (HIU) emulsification is another technique that attracts much attention because it is considered to be eco-friendly and cost-effective.

The acoustic cavitation phenomenon induced by HIU devices can boost the disruption of oil droplets, facilitating the formation of stable emulsions [Trends in Food Science & Technology, Volume 105, November 2020, Pages 363-377]. In the agri-food sector, the use of waves of ultrasonic frequencies was proposed for example for preparing nano-emulsions in an article entitled “The use of ultrasonics for nano-emulsion preparation” by S. Kentisch et al. (Innovative Food Science and Emerging Technologies 9 (2008) 170-175). The method described uses an ultrasonic transducer with a frequency of 20 to 24 kHz. The O/W emulsion obtained has an average droplet size of the order of 135 nm using a mixture of linseed oil and water, in the presence of a surfactant. Further, CN101790978B demonstrates the preparation of pesticide emulsion using ultrasonic emulsification.

As can be seen from the prior art, a large number of combinations of petroleum oils and emulsifiers have been used for making spray oils. However, detailed evaluations of the efficacy of said products depending on the preparation method and the type of the base oil for different crops are rather scarce.

FIG. 1 illustrates a graph 100 depicting molecular configurations of linear alkyl chains varying in length from n=13 to n=21 carbon atoms, with specific emphasis on spatial arrangements and end-to-end molecular distances. The figure presents a systematic array of molecular structures wherein each horizontal row represents a distinct alkyl chain length, progressing from shorter to longer configurations in descending order. Each molecular structure is depicted with explicit carbon-carbon bond arrangements, showing both atomic positions and bond angles characteristic of saturated hydrocarbon chains.

The right-hand axis displays end-to-end molecular distances measured in nanometers, ranging from approximately 1.7164 nm for the shortest chain (n=13) to 2.7416 nm for the longest chain (n=21). A critical structural parameter, identified as the segment separation distance d, is quantified as 0.12814 nanometers, representing the characteristic spacing between adjacent molecular segments.

The molecular geometries are presented in a standardized projection format, with carbon atoms depicted as black nodes and hydrogen atoms as grey spheres. The linear progression of end-to-end distances, indicated by the dotted red line, demonstrates the systematic dimensional increase corresponding to each additional carbon unit in the molecular chain.

This structural analysis, derived from work by N. O. B. Lüttschwager and M. A. Suhm (Soft Matter, 2014, 10, 4885-4901), provides fundamental insights into molecular dimensionality and spatial arrangements relevant to surfactant behavior in emulsion systems.

The volume of oil in the drop decreases rapidly with decreasing the drop diameter, V=⅙ πd³. Thus, for 1 μm drops (d=10⁻⁶ m), the oil volume is approx. 5×10⁻¹⁹ m³, and for 0.1 μm (micrometer) drops (d=10⁻⁷ m), the oil volume is 5×10⁻²² m³. The volume of surfactant will πLd², i.e., 6×10⁻²¹ m³ for 1 μm drops, and 6×10⁻²³ m³ for 0.1 μm drops. It will be understood that for 1 μm drops, the volume of adsorbed surfactant accounts for approx. 1% of the total drop volume, but for 0.1 μm drops, the volume of adsorbed surfactant accounts already for approx. 10% of the overall drop volume. It is well known that surfactant is partitioned between the bulk and the interface, the corresponding partitioning coefficient is described by the so-called adsorption isotherm. Different surfactants have different affinity to the interface and different solubility in oil and water. Therefore, the smaller the desired drop size, the higher surfactant-to-oil ratio in soluble oil formulation is required.

It will be understood that different classification rules may apply depending on the industry. For example, for metalworking fluids, ISO 6743/7 classification is used which defines three categories of emulsions: (i) milky emulsions comprising the L-MAA (Emulsifiable oils with high mineral oil content), L-MAB (Emulsifiable oils with medium mineral oil content), L-MAC (Emulsifiable oils with low mineral oil content) and L-MAD (Emulsifiable oils with very low mineral oil content) classes as per, (ii) microemulsions, the classes L-MAE (Microemulsions with high mineral oil content) and L-MAF (Microemulsions with low mineral oil content), and (iii) synthetic fluids, the classes L-MAG (Microemulsions with varying mineral oil content) and L-MAH (Synthetic fluids that are oil-free, with L-MAH formulated for heavy-duty use). Traditional “milky” emulsions contain 1 to 10% surfactant, and microemulsions contain 10 to 50% surfactant. The so-called micellar solutions contain only surfactants and water, without any oil.

One important characteristic of a surfactant or surfactant mix used in the formulations described herein is its hydrophilic-lipophilic balance (HLB) value. The HLB of a surfactant is a measure of its degree of hydrophilicity or lipophilicity, determined by calculating percentages of molecular weights for the hydrophilic and lipophilic portions of the surfactant molecule. Low HLB surfactants are oil soluble and high HLB surfactants are water soluble.

Referring now to FIG. 2, which illustrates a graphic representation 200 of different base oils showing different polarities. For instance, naphthenic oils are more polar than isoparaffinic oils, which can be traced back to differences in the aniline point. Therefore, it is useful to fine-tune the emulsifier to the type of the base oil used. One convenient formulation technique is to bracket the optimal HLB value by two surfactants, one with a higher than optimal HLB value, and the other one, with a lower than optimal HLB value. Then, by mixing such two surfactants in different ratios, the optimal HLB value for emulsifying a certain base oil type can be easily found from experiments.

Unlike soluble oil formulations used in metalworking, which always contain some excess of emulsifier to accommodate different degrees of dilution, typically from 2 to 10%, soluble oils used for agricultural crop protection are required to have the minimum amount of surfactant to minimize wash off of oil by rain. Therefore, the production of stable emulsions is more challenging, as conventional stirring does not provide sufficient shear forces to break larger drops into smaller ones. After an oil drop gets solubilized, the oil drop surface is covered by a layer of surfactant, and a substantial part emulsifier stays unused having being effectively incapsulated in the oil phase.

### SUMMARY

According to some embodiments, the present disclosure is directed to a method of preparing a sprayable composition for agricultural applications. The method also includes diluting an emulsifiable concentrate with water to form a diluted mixture, where the emulsifiable concentrate may include an oil-in-water nano-emulsion prepared by sonic emulsification of an isoparaffinic hydrocarbon oil, treated water, and a surfactant mixture, the nano-emulsion having oil droplets with a mean size of 10 to 100 nanometers and a surfactant content of 3.0 to 4.5 percent by mass.

The method also includes adding an agricultural active ingredient to the diluted [symbol] nano-emulsion to form the sprayable composition. The sprayable composition, when applied to crops at predetermined amount of liters per hectare, increases leaf retention time by at least 50% compared to oil-in-water emulsions containing 30% by mass surfactant, reduces agrochemical runoff by at least 50% as measured by residue analysis compared to the emulsions, reduces total oil charge per hectare by at least 66% compared to the emulsions, and reduces application frequency by at least 25% while maintaining at least 90% pest control efficacy as measured by pest mortality within a period of time.

Implementations may include one or more of the following features. The method where the sprayable composition is diluted to a concentration of 1-2% by volume of the emulsifiable concentrate. The agricultural active ingredient is selected from at least one of insecticides, fungicides, and herbicides.

Another general aspect includes a method of treating agricultural crops to enhance pest resistance. The method also includes preparing a sprayable treatment by combining water, an agricultural active ingredient, and an emulsifiable concentrate in predetermined ratios, where the emulsifiable concentrate may include an oil-in-water nano-emulsion prepared by sonic emulsification having oil droplets with a mean size of 10 to 100 nanometers. The method also includes applying the sprayable treatment to crop foliage during a predetermined growth stage window. The method also includes achieving enhanced pest control efficacy with reduced active ingredient loading compared to conventional emulsion treatments.

Implementations may include one or more of the following features. The method where the water, agricultural active ingredient, and emulsifiable concentrate are combined in a ratio of approximately 22.5 to 1.0 to 6.3 by mass. The water, agricultural active ingredient, and emulsifiable concentrate are combined in a ratio of approximately 2500 to 4 to 2 by mass. The crops may include banana plants and the sprayable treatment is applied to control sigatoka fungus infection. The method includes conducting two sequential applications separated by a predetermined time interval during the crop growing season. The crops may include pineapple plants and the agricultural active ingredient may include diazinon for controlling mealybug infestation. The sprayable treatment is applied using spray intensity according to an applicable protocol for a target crop and pest combination. The predetermined growth stage window corresponds to pineapple flowering stages between open heart and early anthesis. The predetermined ratios and application parameters are selected according to standardized agricultural protocols specific to the target crop and pest combination. The method utilizes a more diluted emulsifiable concentrate ratio for insect control applications compared to fungal control applications. The sprayable treatment maintains emulsion stability for at least 40 minutes after preparation under field conditions.

Another general aspect includes a method of controlling plant fungal infections through aerial application. The method also includes formulating a treatment mixture containing water, fungicide, and an emulsifiable concentrate prepared by sonic emulsification, where the treatment mixture contains oil droplets having a mean size of 10 to 100 nanometers. The method also includes applying the treatment mixture to plant foliage via aerial spraying equipment using spray intensity according to the applicable protocol. The method also includes maintaining fungal control effectiveness while reducing total surfactant content and oil charge by at least 40% compared to conventional fungicide emulsions.

Implementations may include one or more of the following features. The method where the treatment mixture is applied during morning hours between 8:00 am and 9:00 am in the absence of wind and precipitation. The fungicide may include at least one compound selected from the group may include of propiconazole, difenoconazole, and azoxystrobin. The aerial application achieves droplet coverage that remains adherent to leaf surfaces for at least 24 hours under field conditions. The method reduces fungicide application frequency by at least 25% while maintaining at least 90% disease control compared to conventional treatments.

### BRIEF DESCRIPTION OF THE DRAWINGS

FIG. 1 illustrates molecular configurations of linear alkyl chains varying in length, with end-to-end molecular distances and spatial arrangements depicted.

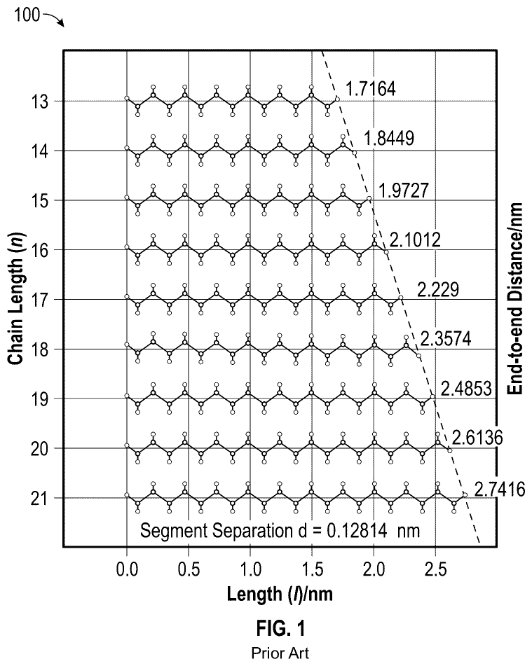

FIG. 2 presents a comparison of base oil polarities, distinguishing between naphthenic and isoparaffinic oils, and demonstrating emulsification characteristics based on hydrophilic-lipophilic balance (HLB) values.

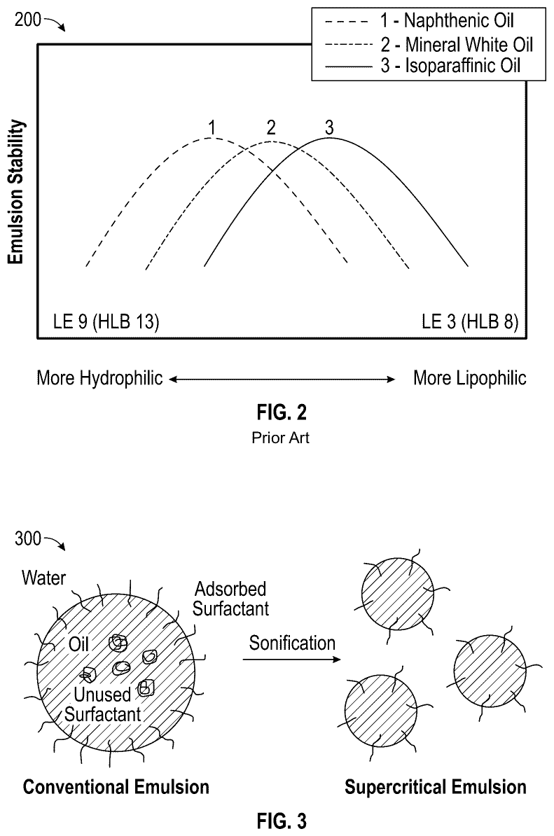

FIG. 3 depicts the structural transformation of emulsions from conventional architectures to supercritical nano-emulsions achieved via ultrasonic processing, emphasizing optimized surfactant utilization and reduced droplet size.

FIG. 4 provides comparative droplet size distribution profiles, highlighting the superior dimensional uniformity of supercritical nano-emulsions relative to conventional “milky” emulsions.

FIG. 5 illustrates an attenuated-total-reflectance Fourier-transform infrared (ATR-FTIR) spectrum of a sustainable isoparaffinic base oil, confirming its predominantly paraffinic composition and negligible aromatic content.

FIG. 6 illustrates a proton nuclear-magnetic-resonance (1H-NMR) spectrum of the same isoparaffinic base oil, verifying its aliphatic chain structure and absence of significant unsaturation or heteroatom-bearing moieties.

FIG. 7 illustrates quantitative field-trial data plotting droplet-coverage density against material-recovery rate for aerial applications of a supercritical nano-emulsion formulation under controlled agricultural conditions.

FIG. 8 illustrates the field trial results for a conventional emulsion preparation, focusing on leaf coverage density and material recovery rates under controlled agricultural conditions

FIG. 9 and FIG. 10 each illustrate photomicrographic analyses of hydrosensitive card data, demonstrating uniform droplet deposition and size distribution achieved with the supercritical nano-emulsion formulation.

FIG. 11 illustrates schematic of the raw material processing system, detailing the handling of isoparaffinic oil, treated water, and surfactants, and their integration into a centralized ultrasonic processing system.

FIG. 12 illustrates an example computer system for controlling ultrasonic processing, material flow, and environmental conditions to ensure consistency in nano-emulsion production.

FIG. 13 depicts a banana leaf segment showing a treated square area of healthy green tissue surrounded by untreated regions exhibiting extensive sigatoka fungal damage.

FIG. 14 depicts a banana leaf with visible treatment droplets maintaining adherence to the leaf surface following aerial application.

FIG. 15 depicts seven developmental stages of pineapple flowering from open heart through dry petal phases, defining critical application timing windows.

FIG. 16 depicts environmental monitoring data including precipitation, temperature, humidity, and solar radiation measurements recorded during field trials.

FIG. 17 depicts a flowchart illustrating the general method for preparing sprayable compositions for enhanced agricultural applications.

FIG. 18 depicts a flowchart illustrating the method for controlling fungal infections in banana plantations through aerial application.

FIG. 19 depicts a flowchart illustrating the method for controlling mealybug infestations in pineapple plantations through ground-based application.

FIG. 20 depicts a flowchart illustrating the comprehensive method for selecting and implementing crop treatment protocols across different agricultural applications.

### DETAILED DESCRIPTION OF EXAMPLE EMBODIMENTS

### Overview

The present disclosure pertains to formulations such as an oil-in-water nano-emulsion, offering enhanced effectiveness, environmental compatibility, and versatility. Example formulations comprise isoparaffinic hydrocarbon oil, non-ionic surfactants, and purified water, resulting in a stable emulsion suitable for pest and disease control.

An example method uses ultrasonic-assisted processing to achieve nano-sized droplets, increasing surface area coverage and extending residence time on crop surfaces. The process utilizes high-energy sonication to reduce droplet size to levels not attainable with conventional homogenization techniques, while maintaining emulsion stability and functionality. This ultrasonic process is carried out under controlled parameters to ensure thermal stability of the components.

The stability of the emulsion is further achieved through a specific combination of surfactants, including alcohol ethoxylates, sorbitan esters, and ethoxylated sorbitan esters. These surfactants, selected based on their hydrophilic-lipophilic balance (HLB), work synergistically to stabilize the emulsion and provide consistent performance under various conditions. The formulation is environmentally friendly and biodegradable.

This composition is adaptable and can incorporate additional agrochemical agents, such as pesticides or nutrients, without compromising its stability or performance. The flexibility in ingredient ratios allows tailoring to specific crop needs and agricultural conditions.

### EXAMPLE EMBODIMENTS

The present disclosure demonstrates the use of a sustainable isoparaffinic oil produced from waste plastic for agricultural spray oil preparations. One example advantage of using a sustainable base oil is its lower carbon footprint and lower phytotoxicity compared to traditional formulations. Sonic emulsification has been used to prepare supercritical emulsions that require less emulsifier than conventional preparations.

Spray oil preparations produced according to the present disclosure demonstrate superior efficacy compared to other competing products while greatly reducing the oil demand per hectare. In the field trials, emulsions produced according to the present disclosure demonstrated leaf retention up to 80%, whereas traditional formulations never exceed 60 to 70% retention. With a typical spray rate of around 20 liters per hectare, this will give substantial cost savings, taking into account that the total area of farmland in Latin America amounts to over 600 million hectares.

In the context of the present disclosure, supercritical emulsions are defined as the emulsions that use the minimum possible amount of emulsifier to ensure emulsion stability at a given drop size. Alternatively, supercritical emulsions can be defined as stable emulsions with minimum droplet size possible to achieve for the given amount of emulsifier in the formulation. Due to differences in specific gravity of water and oil, oil tends to skim at the surface. By reducing the oil droplet size, one can reduce the tendency for skimming but at the same time the demand for emulsifier increase.

Using ultra high shear emulsification via ultrasound sonification or cavitating jet emulsification, supercritical emulsions can be produced that contain virtually no unused surfactant in the oil phase. Such emulsions also have more narrow drop size distribution of approximately 0.1 μm average drop size.

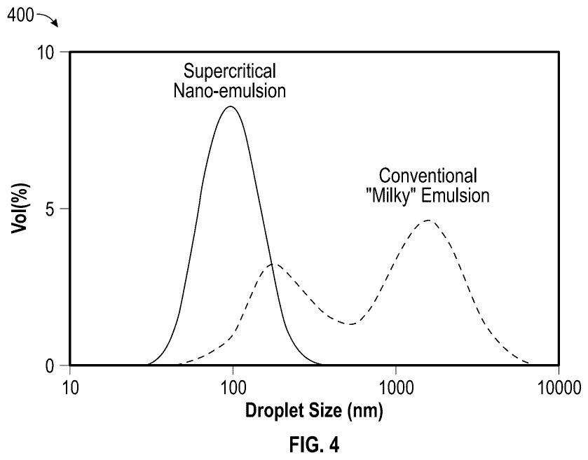

FIG. 3 depicts a comparative illustration 300 demonstrating the structural transformation between conventional and supercritical emulsion architectures through sonification processing. The comparative analysis presents two distinct morphological states of the emulsion system, with specific emphasis on surfactant utilization and droplet configuration characteristics.

In the conventional emulsion architecture, depicted on the left side of the illustration, a singular large-diameter dispersion contains both surface-active molecules positioned at the oil-water interface and unutilized surfactant components retained within the internal oil phase. The interfacial region exhibits characteristic amphiphilic molecular orientation, wherein hydrophilic moieties extend into the aqueous phase while hydrophobic segments maintain orientation toward the oil phase interior.

Upon application of controlled sonification energy, the system undergoes substantial morphological reorganization, resulting in the formation of multiple discrete droplets characterized by significantly reduced diametrical dimensions, designated as the supercritical emulsion state. These resultant formations demonstrate uniform dimensional characteristics while maintaining interfacial surfactant coverage, notably with previously unutilized surfactant molecules now participating in interface stabilization functions.

The supercritical emulsion morphology exhibits several distinguishing characteristics, including optimized surfactant distribution across all formed interfaces, elimination of entrapped unutilized surfactant within the oil phase, achievement of uniform droplet size distribution parameters, enhanced interfacial stabilization mechanisms, and overall reduction in total system volume.

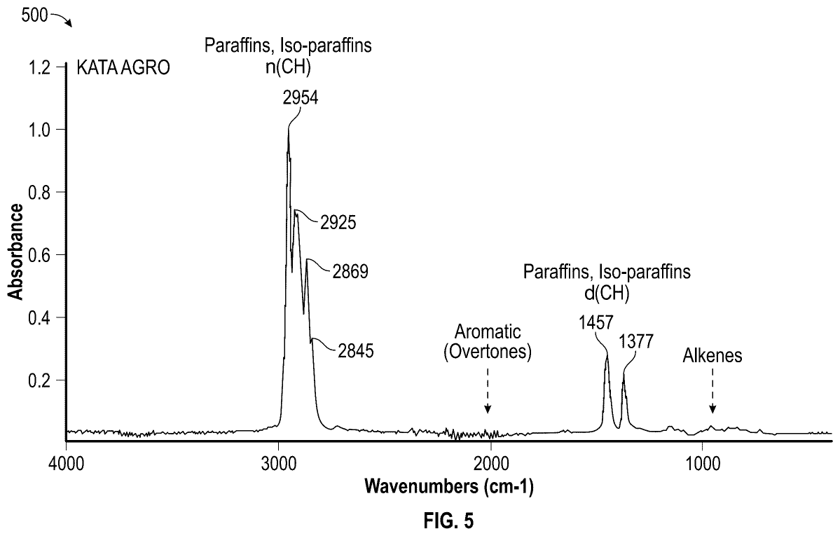

FIG. 4 presents comparative droplet size distribution profiles 400 characterizing the dimensional architectures of supercritical nano-emulsions and conventional “milky” emulsions. The graphical representation depicts droplet volume percentage (VOL %) as a function of droplet size measured in nanometers (nm), utilizing a logarithmic scale spanning from 10 to 10,000 nanometers.

The supercritical nano-emulsion, represented by a solid line, exhibits a singular, well-defined peak centered approximately at 100 nanometers, characterized by a narrow distribution profile and enhanced volume percentage reaching approximately 8%. This monomodal distribution demonstrates precise dimensional control achieved through optimized processing parameters.

In contrast, the conventional “milky” emulsion, depicted by a dashed line, presents a bimodal distribution with significantly broader dimensional variance. The first peak appears at approximately 100 nanometers with reduced intensity, while a second, broader peak manifests at approximately 2000 nanometers. This bimodal characteristic indicates suboptimal droplet formation and size control inherent to conventional emulsification methodologies.

The comparative analysis demonstrates superior dimensional uniformity achieved through supercritical emulsification protocols, evidenced by the absence of secondary peaks and substantially reduced dimensional variance. This enhanced control over droplet architecture directly correlates with improved formulation stability and application effectiveness.

The quantitative dimensional analysis supports advanced emulsion engineering principles, wherein precise control over droplet size distribution parameters enables achievement of optimal performance characteristics in agricultural spray oil applications.

It is well known that sufficiently concentrated oil-in-water emulsions reveal non-Newtonian rheology (see e.g. H. A. Barnes, Rheology of emulsions, a review, Colloids and Surfaces A: Physicochemical and Engineering Aspects, 91 (1994) 89-95). If the emulsified oil fraction exceeds approximately 20%, a shear-thinning effect can be measured. Oil droplets in surfactant-stabilized emulsions are surrounded by a hydration layer formed by the hydrogen bonding between the polar ends (ethoxylate or sugar units) of surfactant molecules and water molecules. Therefore, the non-Newtonian behavior is especially pronounced in supercritical emulsions according to the present invention as narrow droplet size distribution allows dense droplet packing that promotes associative phenomena.

At the same time, diluted emulsions where oil fraction is below 10% demonstrate a nearly Newtonian behavior. The combination of properties is very important for the intended end-use of the product as agricultural spray oil. First factor is that the concentrated nano-emulsion prepared according to the present invention reveal excellent storage stability due to their “creamy” consistency which prevents oil separation. However, before the actual application by spraying, the original concentrate is diluted by water. The resulting diluted emulsion is easy to spray in a controlled way due its low viscosity and nearly Newtonian behavior. As the excess water evaporates as spray droplets travel to the plants, the oil/water ratio increases and the emulsion regains its thixotropic properties. As a result, the emulsion droplets that hit the leaves of the plant demonstrate excellent retention and virtually no run-off. This is especially beneficial for protecting crops that demonstrate the so-called “lotus effect” when water drops falling onto the leaves can bead up and roll off.

In some embodiments, the preparation of stable oil-in-water nano-emulsions requires specific material selection. The oil phase includes an isoparaffinic hydrocarbon oil substantially free of naphthenic compounds and heteroatoms. Specific attributes of the oil phase can be confirmed through CHNSO elemental analysis, 1H and 13C Nuclear Magnetic Resonance (NMR) and Fourier Transform Infrared (FTIR) analysis. The branched (isoparaffinic) structure minimizes phytotoxicity risks to treated plants. Suitable base oil types include severely hydrotreated and hydroisomerized base oils, gas-to-liquid (GTL) and coal-to-liquid (CTL) base oils, alkylate base oils, and as a preferred option, sustainable base oils produced by waste plastic upcycling, with viscosities from ISO VG 3 to 10. Table 1 illustrates the physicochemical properties of sustainable isoparaffinic oil produced from waste plastic.

TABLE 1

| Property | Method | Value |
|---|---|---|
| KV40, cSt | ASTM D445 | 3.9 |
| KV100, cSt | ASTM D445 | 1.4 |
| Specific gravity @ 15° C., | ASTM D1298 | 0.81 |
| g/cm³ | | |

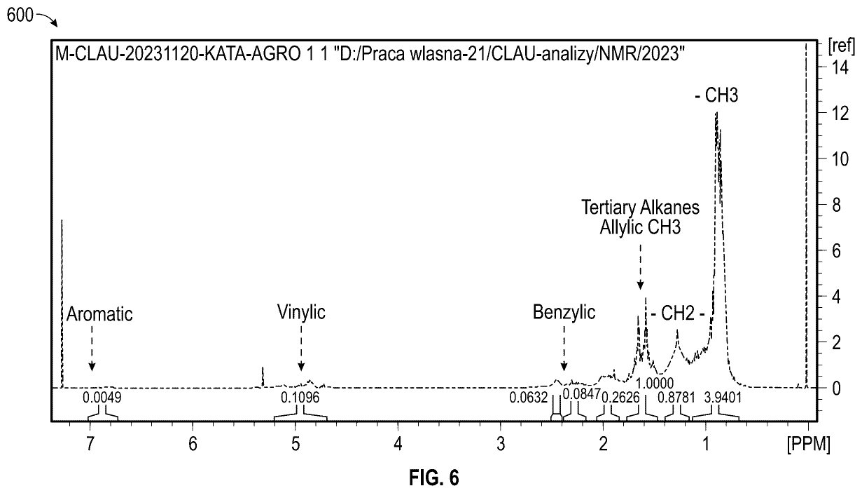

As illustrated in FIG. 5, which includes a graphical representation 500, the ATR-FTIR (Attenuated Total Reflection Fourier Transform Infrared) and NMR (Nuclear Magnetic Resonance) analysis of the oil proves that that this a pure isoparaffinic oil containing only trace amounts of naphthenes and aromatics.

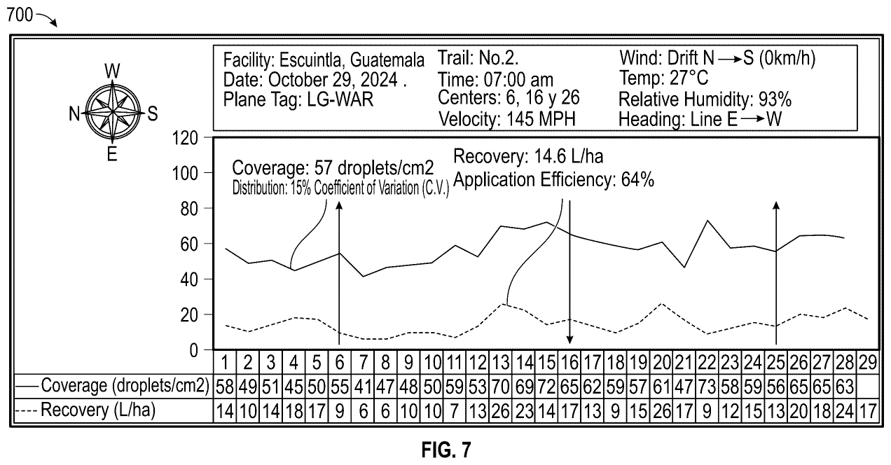

FIG. 6 presents the nuclear magnetic resonance (NMR) spectral characterization 600 of KATA AGRO oil, demonstrating comprehensive molecular structural analysis across the chemical shift domain of 0-8 parts per million (PPM). The spectral acquisition parameters have been optimized to provide high-resolution characterization of hydrocarbon molecular architectures, with particular emphasis on identification and quantification of specific structural moieties.

The spectrum exhibits a series of well-resolved resonance features, with dominant signals characteristic of saturated hydrocarbon structures. The most prominent resonance appears at approximately 0.9 ppm, corresponding to terminal methyl (—CH3) groups, while methylene (—CH2-) resonances manifest at approximately 1.3 ppm. These primary signals demonstrate intensity distributions consistent with predominantly isoparaffinic molecular architecture.

Secondary spectral features include low-intensity resonances in regions characteristic of specific structural elements. Tertiary alkane and allylic methyl signals appear at approximately 1.8 ppm, while minimal benzylic resonances are observed at approximately 2.3 ppm. The spectrum further reveals trace vinylic signals at approximately 4.8 ppm and negligible aromatic resonances in the region of approximately 7.0 ppm, confirming minimal unsaturated and aromatic content.

A first surfactant family comprises fatty alcohol ethoxylates (AE), and in one embodiment lauric alcohol ethoxylates (LAE) containing 7 to 9 ethylene oxide (EO) moieties. Suitable commercial products are manufactured by P&G Chemicals, Clariant, BASF, Akzo Nobel, Huntsman International, Ecogreen Oleochemicals and others. The alcohol ethoxylates provide a range of hydrophile-lipophile balance (HLB) values for optimizing emulsion characteristics.

Additional surfactant families include ethoxylated and non-ethoxylated sorbitan esters. The ethoxylated sorbitan esters, particularly polysorbate 20, provide high HLB values effective for oil-in-water (O/W) emulsion stabilization. Known manufacturers of polysorbates are BASF, Croda, PCC Group, KAO Chemicals, KeanChem, and others, under trade names Kolliphor PS 20, Scattics, Alkest TW 20, Tween 20, Kotilen 20, etc. These materials demonstrate biodegradability and compatibility with agricultural and pharmaceutical applications.

In one specific example, non-ethoxylated sorbitan esters, such as sorbitan monooleate, provide low HLB values effective for water-in-oil emulsion stabilization. Sorbitan monooleate is manufactured by Croda, BASF, Indorama, PCC Group, Stepan, Spell Organics, Univenture, Syskem Chemie, Guangdong Huana Chemical, Chemsino, and others, under names Span 80, Dehymuls SMO, Alkest SP 80, Toximul SEE-341, SMO, and so forth. These materials find broad application in food, cosmetic, and pharmaceutical products. As explained in the background section, the combination of surfactants with complementary HLB values enables formation of stable nano-emulsions with consistent physical properties.

The water or aqueous phase requires specific treatment protocols. An example process includes sequential water treatment steps such as initial softening followed by reverse osmosis filtration to achieve pH between 5.0-6.5 and conductivity below 10 microsiemens per centimeter. These parameters ensure consistent water quality for standardized production and emulsion stability.

The treated water's high purity level prevents destabilization from pH variations and eliminates interference from dissolved salts. This characteristic becomes important when the nano-emulsion serves as a carrier for additional agricultural active ingredients, as the absence of interfering ions provides compatibility with a broad range of agricultural chemicals.

The agricultural spray formulation may further comprise 0.1 to 10.0 percent by mass of an agricultural active ingredient, wherein said agricultural active ingredient is selected from the group consisting of insecticides, fungicides, acaricides, nematicides, bactericides, plant growth regulators, herbicides, molluscicides, algaecides, defoliants, desiccants, chemosterilants, repellents, pheromones, attractants, medicaments, plant nutrients, and combinations thereof. In certain embodiments, the agricultural active ingredient may include systemic compounds capable of being absorbed and translocated within plant tissues, contact compounds that remain substantially on treated surfaces, or combinations thereof. The active ingredients may be incorporated in their pure form, as technical concentrates, or as formulated products. When formulated products are utilized, the active ingredients may be combined with auxiliary substances such as carriers, solvents, surface-active compounds, or other adjuvants that enhance biological efficacy, provided that such auxiliary substances do not materially affect the essential characteristics of the nano-emulsion. The selection and concentration of active ingredients may be optimized based on target organisms, environmental conditions, crop type, and application timing, with the nano-emulsion serving as an optimized delivery system that enhances both initial coverage and sustained biological activity through controlled release characteristics inherent in the emulsion architecture.

As detailed in Table 2, the formulation encompasses a range of concentrations for each component, allowing for tailored adjustments to meet specific application needs. The isoparaffinic oil concentration, for instance, ranges from 20.0% to 60.0% by mass, ensuring flexibility while maintaining emulsion stability.

TABLE 2

| | Isoparaffinic | Sorbitan | Ethoxylated | Alcohol |
|---|---|---|---|---|
| Water | Oil | esters | sorbitan esters | ethoxylate |
| 25.0-80.0% | 20.0-60.0% | 0.0-5.0% | 0.0-5.0% | 0.0-5.0% |

The formulation, expressed in mass percentages, provides formulation flexibility to address varying application requirements. The isoparaffinic oil concentration ranges from 20.0 to 60.0 percent, with preferred concentrations between 30.0 and 50.0 percent, and optimal performance typically achieved between 30.0 and 35.0 percent. The non-ionic surfactants are incorporated at 0.0 to 5.0 percent each, preferably between 1.0 and 2.0 percent, with optimal ranges between 1.0 and 1.5 percent. The total amount of emulsifier ranges from 1 to 10% by mass. In some embodiments, water comprises the balance to 100 percent.

When mixed with different agricultural active ingredients, adjustment of surfactant ratios within the disclosed ranges maintains stability while accommodating the varying chemical properties of different active ingredients. This tailored approach provides optimal performance when the formulation serves as a carrier for commonly used agricultural chemicals from major manufacturers, without compromising the core stability and performance characteristics.

The selected non-ionic surfactant families operate synergistically through complementary HLB values. The ethoxylated lauric alcohol (ALE 9) and polysorbate 20 (Tween 20) provide high HLB values of 13.4 and 16.7 respectively, promoting oil-in-water emulsion stability. In contrast, sorbitan monooleate (SPAN 80) contributes a low HLB value of 4.3, enhancing water-in-oil emulsion characteristics. This combination of surfactants with divergent HLB values facilitates formation and stabilization of nano-scale droplets within the emulsion structure.

In a preferred embodiment, the surfactant mixture comprises precisely controlled proportions of three complementary non-ionic surfactants: (i) 1.0 to 1.5 percent by mass of fatty alcohol ethoxylate, specifically lauric alcohol ethoxylates containing seven to nine ethylene oxide units (HLB 12-14), (ii) 1.0 to 1.5 percent by mass of sorbitan monooleate (HLB 4-5), and (iii) 1.0 to 1.5 percent by mass of polyoxyethylene twenty sorbitan monolaurate (HLB 16-17). This precise tripartite formulation ensures optimal interfacial stabilization through complementary HLB values while maintaining minimal total surfactant content to prevent excessive wash-off during agricultural application. The narrow concentration ranges for each surfactant component have been experimentally determined to provide optimal emulsion stability while facilitating the achievement of the desired nano-scale droplet architecture during ultrasonic processing.

The nano-emulsion, when applied at rates between 10 and 30 liters per hectare using appropriate spraying equipment, produces a uniform distribution of droplets having a size distribution between 10 and 100 nanometers. This correlation between application rate and droplet size distribution has been experimentally validated across multiple field trials and is critical for achieving the desired coverage density of at least 60 droplets per square centimeter. The maintenance of nano-scale droplet dimensions during the spraying process is facilitated by the specific surfactant composition and concentrations detailed above, which provide sufficient interfacial stabilization to prevent droplet coalescence during transit while enabling optimal spreading behavior upon plant surface contact.

The nano-emulsion preparation involves a specific sequence of mixing and processing steps. First, water, isoparaffinic oil, and emulsifiers are pre-mixed using vigorous agitation at room temperature. Due to its high pour point, the ethoxylated lauric alcohol (ALE 9) requires preheating to 40 degrees Celsius to ensure proper solubilization. After that, the mixture is subjected to sonification.

In one embodiment, the mixture is continuously circulated through an ultrasonic processor chamber for enhanced component dispersion. The ultrasonic processor operates at 1500-2000 watts, typically 1800 watts, with energy transmitted via a piezoelectric sonotrode vibrating at 20 kilohertz frequency. The typical volume of the mixture being processed is around 3000 L, and the flow rate 40 to 80 liters per minute, and the total processing time is 10 to 20 hours. During the process, 15,000 to 40,000 watt-hours of energy is supplied to the system, meaning the energy demand of 5 to 15 watt-hours per liter. The sonic energy is being pumped into the mixture within the sonotrode chamber with the minimum sonic power density in excess of 10 watt per liter, and preferably in excess of 100 watt per liter for efficient emulsification in a flow-through process. The process output can be easily scaled up or down using sonotrodes with different power and flow rate. For example, using a sonotrode with 3,600 Watts of power instead of 1,800 Watts of power, one can double the flow rate and either halve the processing time or double the volume of the mixture being processed.

High-frequency sonotrode movement produces significantly smaller droplet sizes compared to conventional emulsion homogenization methods. While the sonification process generates heat, temperature control is critical as each component has a specific degradation threshold—the temperature at which the material begins to chemically or physically degrade. For the surfactants used in this system, temperatures above 45 degrees Celsius can cause decomposition or loss of emulsification properties. Similarly, the isoparaffinic oil components may undergo undesired chemical changes above this temperature. Therefore, maintaining temperature below 45 degrees Celsius through a water-cooled jacket system prevents thermal degradation of both the individual components and the resulting nano-emulsion system. After achieving the desired energy input, the processed nano-emulsion transfers to containers for quality control evaluation.

The ultrasonic processing generates initial droplet formation, but long-term stability may depend on emulsifier composition. Extensive testing of surfactant combinations revealed that stable nano-scale droplets require both proper ultrasonic processing parameters and specific emulsifier ratios. The combination of precise ultrasonic energy input and optimized surfactant selection enables formation of stable droplets at sizes difficult to achieve through conventional methods.

There are a number of commercial techniques suitable for sonic-assisted emulsification according to the present invention. These include but are not limited to jet cavitators, such as DynaSwirl® Cavitating Swirling Jets from DynaFlow Inc., SL-series of cavitation jet machines (Zhongsen Huijia Technology, Beijing, China), and CCBL jets (GQOil, Poland), and ultrasonic emulsifiers manufactured by Hielscher, Putsonic, Hangzhou Altrasonic, etc.

Field testing conducted across multiple continents demonstrated significant economic and environmental advantages through reduced oil consumption. The formulation achieves equivalent or superior crop protection while utilizing approximately 60% less oil compared to conventional treatments. This reduction in oil usage, combined with the enhanced stability and performance characteristics, provides substantial benefits to agricultural operations without compromising effectiveness.

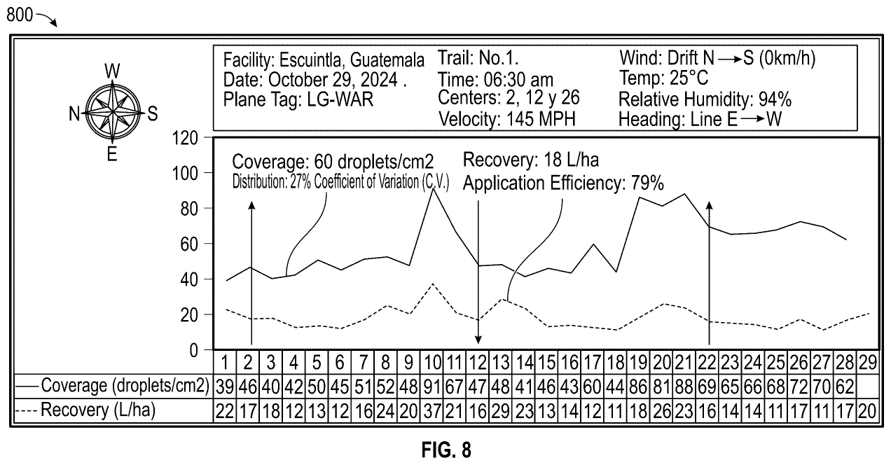

FIG. 7 illustrates quantitative field trial data demonstrating application efficacy parameters for supercritical nano-emulsion deployment under controlled agricultural conditions, in the form of a graph 700. The trial was conducted at Escuintla, Guatemala facility utilizing precision aerial application methodologies, with environmental parameters maintained at 27° C. temperature and 93% relative humidity under minimal wind conditions (derived N→S at 0 km/h).

The graphical representations depict dual-parameter tracking across 29 measurement intervals, monitoring both surface coverage density (measured in droplets per square centimeter) and material recovery rates (measured in liters per hectare). The coverage density profile, indicated by the upper trace, demonstrates consistent droplet distribution averaging 57 droplets per square centimeter with a coefficient of variation of 15%, validating uniform application characteristics.

Material recovery rates, represented by the lower trace, exhibit a mean value of 14.6 L/ha with an application efficiency coefficient of 64%. The deployment parameters were maintained at 145 MPH aerial velocity with specific focus on centers 6, 16, and 26 for detailed analytical assessment, as indicated by the vertical assessment markers.

The integrated data set confirms achievement of optimal coverage metrics while maintaining efficient material utilization rates, demonstrating superior performance characteristics of the supercritical nano-emulsion formulation under field deployment conditions. The achieved coverage density and recovery parameters support enhanced leaf retention capabilities, with measured retention values averaging 79% across the trial duration.

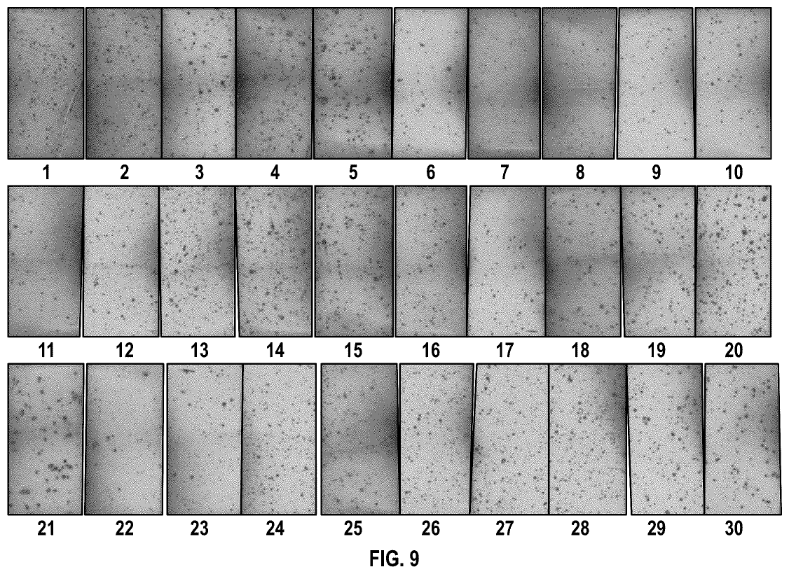

FIG. 8 illustrates the field trial results for a conventional emulsion preparation, focusing on leaf coverage density and material recovery rates under controlled agricultural conditions, in the form of a graph 800. The trials were conducted at the Escuintla, Guatemala facility, with environmental parameters including a temperature of 25° C., relative humidity of 94%, and wind drift conditions of zero (N→S, 0 km/h). The application was performed at an aerial velocity of 145 MPH, with data collected over 29 intervals.

The graph demonstrates leaf coverage density, expressed in droplets per square centimeter, with an average value of 57 droplets/cm² and a coefficient of variation of 27%. The coverage profile reveals noticeable inconsistencies, with periodic spikes and troughs indicative of non-uniform droplet distribution across the treated area. This variability highlights the limitations of conventional emulsions in achieving consistent deposition, particularly under fluctuating application conditions.

Material recovery rates, measured in liters per hectare, averaged 18 L/ha, with observed deviations across the sampling intervals. While the overall recovery rate is indicative of acceptable efficiency, the larger droplet sizes characteristic of conventional emulsions contribute to uneven retention on crop surfaces. This results in areas of reduced coverage and increased susceptibility to runoff, particularly on hydrophobic leaf surfaces.

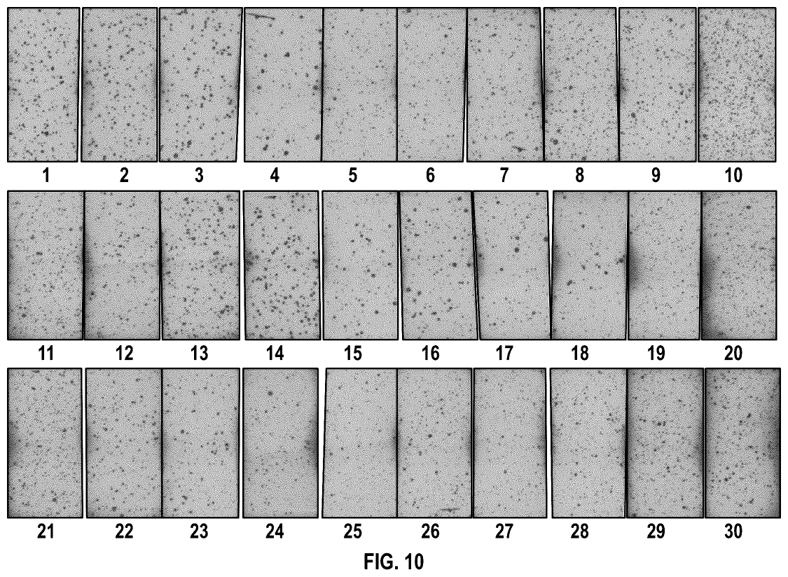

FIG. 9 and FIG. 10 each illustrate photomicrographic analyses of hydrosensitive card data (e.g., 1-30) demonstrating droplet deposition characteristics achieved through application of the supercritical nano-emulsion formulation. The analytical field displays systematic droplet distribution patterns manifested through localized staining on the hydrosensitive substrate (e.g., crop surface), wherein the chromatic differentiation between the crop surface and the impact-initiated droplet sites enables quantification of spatial distribution parameters.

The patterns demonstrate consistent droplet allocation achieving a mean density of 60 droplets per square centimeter across the evaluated zones. Individual droplet manifestations exhibit controlled dimensional parameters, validating maintenance of targeted particle size distributions throughout the application sequence.

The sequential evaluation zones validate stability of application parameters across the treatment field, with minimal variation in droplet density or distribution characteristics between measurement locations. The documented coverage patterns provide empirical validation of enhanced surface interaction dynamics achieved through the supercritical nano-emulsion architecture, demonstrating superior uniformity compared to conventional formulation methodologies.

The consistency of droplet distribution characteristics across the analytical field confirms maintenance of optimal application parameters throughout the deployment sequence, thereby validating the efficacy of the ultrasonic processing methodology in achieving targeted atomization characteristics. The hydrosensitive card analysis provides quantitative verification of uniform coverage parameters essential for optimal agricultural spray performance.

The formulations disclosed herein demonstrate versatility when combined with common agricultural chemicals. A smaller and more uniform size of oil droplets ensures better adhesion with leaves and more uniform distribution of active ingredients. Extensive compatibility testing with widely-used agrochemicals from major manufacturers confirmed that the formulation maintains its stability and performance characteristics when mixed with these products. This compatibility enables efficient integration into existing agricultural spray programs without requiring separate application cycles. The formulation's stability and effectiveness remain consistent across various mixing ratios and chemical combinations, allowing flexible adaptation to specific crop protection needs.

The resulting nano-emulsion exhibits distinctive physical and performance properties. Field trials conducted across multiple countries and crops over six growing seasons demonstrate enhanced residence time and agricultural impact compared to existing market products. The improved performance derives from superior wetting properties attributable to nano-scale droplet size and the presence of ethoxylated lauric alcohol. The isoparaffinic structure provides lower surface tension compared to linear isomers, promoting film formation and leaf surface coverage. These characteristics enable complete leaf coverage and enhanced retention, even under adverse weather conditions including heavy rainfall.

Environmental and safety testing conducted under standardized protocols confirms favorable characteristics. Biodegradability testing according to Organization for Economic Co-operation and Development (OECD) Method 301B, demonstrates biodegradability of the product. Ecotoxicity testing shows minimal environmental impact, with high lethal dose values for bees, fish, Lemna gibba, and Daphnia magna. Safety evaluation reveals no eye or skin irritation potential, no skin sensitization, and high lethal dose values for oral, inhalation, and dermal exposure routes.

The nano-emulsion maintains stability characteristics across various conditions. The composition appears white with a creamy texture and demonstrates stability for 6, 9, and 12 months under ambient temperature conditions including normal daily temperature fluctuations. Cold stability testing according to Method 39.3 of the Collaborative International Pesticides Analytical Council (CIPAC MT 39.3) confirms stability at 0 degrees Celsius for 7 days without separation.

Biodegradation studies reveal significant environmental advantages compared to conventional agricultural oils. The formulation achieves complete biodegradation within approximately 90 days under standard test conditions, compared to typical degradation periods of two years or more for conventional agricultural spray oils. This rapid biodegradation characteristic reduces environmental impact while maintaining required residual activity for crop protection.

Physical characterization includes multiple analytical parameters. The Brix grade (degrees Brix) indicates mixing effectiveness and correlates with droplet size reduction. Ultrasonic processing achieves mean droplet sizes of approximately 20 nanometers. Dynamic viscosity provides an additional control parameter, increasing with decreased droplet size due to enhanced surface area effects. Both Brix grade and viscosity measurements demonstrate dependence on oil concentration in the final composition.

### Methods of Production

A high-level process flow for the production of a stable nano-emulsion comprising five sequential stages. In a first step, raw material receipt and inspection, incoming materials are subjected to quality control measures to verify compliance with predefined specifications, ensuring their suitability for processing. Following inspection, a second step involves storing the raw materials in dedicated facilities under controlled environmental conditions, including temperature, humidity, and containment parameters, to maintain their integrity. A third step encompasses the mixing and emulsion process, where the core manufacturing occurs through precise control of component addition sequences, agitation conditions, and ultrasonic processing parameters to achieve the desired nano-emulsion properties. Once processed, the finished product is stored under monitored conditions in a fourth step to preserve its stability and quality pending final quality assurance testing. In a fifth step, the product is packaged and dispatched according to customer requirements, completing the production process.

A process for producing a stable agricultural spray oil nano-emulsion involves careful control over component selection, processing conditions, and energy application to achieve the desired emulsion characteristics. The process begins by combining treated water, an isoparaffinic hydrocarbon oil, and a surfactant mixture in a mixing chamber to form a pre-emulsion. The surfactant mixture includes a fatty alcohol ethoxylate with seven to nine ethylene oxide units, providing a hydrophilic-lipophilic balance (HLB) value between 12 and 14, sorbitan monooleate with an HLB value in the range of 4 to 5, and polyoxyethylene twenty sorbitan monolaurate, which contributes a high HLB value of 16 to 17. The selection of surfactants with complementary HLB values promotes effective emulsification and stability of the oil-in-water system.

Once the pre-emulsion is formed, it is subjected to ultrasonic energy under controlled conditions. The ultrasonic frequency is maintained at approximately 20 kilohertz, with a sonic wave power density exceeding 10 watts per liter, and a total energy input in the range of 0.5 to 50 watt-hours per liter. These energy parameters facilitate nano-scale droplet formation while enabling efficient droplet size reduction. At the same time, the temperature of the mixture is maintained below 45 degrees Celsius using a cooling system, as this threshold avoids thermal degradation of the surfactants and the isoparaffinic oil, preserving the properties of the resulting nano-emulsion.

The ultrasonic processing continues until a stable nano-emulsion is produced, characterized by a mean droplet size in the range of 10 to 100 nanometers and a monomodal droplet size distribution. This narrow and uniform droplet size supports emulsion stability and performance, particularly for agricultural spray applications. The resulting nano-emulsion resists phase separation under ambient conditions, ensuring extended shelf life and consistent behavior during field application. By balancing the surfactant composition, energy input, and thermal regulation, the process provides a stable nano-emulsion optimized for agricultural use.

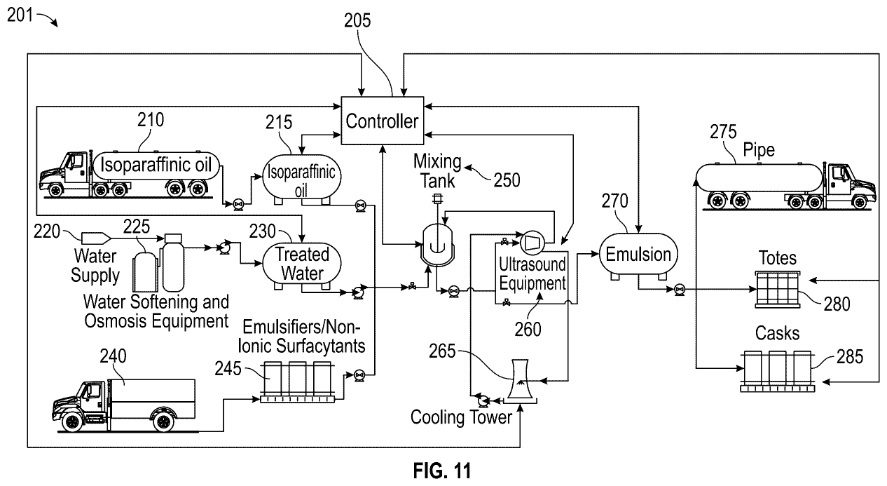

FIG. 11 illustrates a schematic comprising three parallel raw material inputs that converge in a central processing system 201. The first stream involves isoparaffinic oil handling, starting with tanker delivery 210, which uses positive displacement pumps to transfer oil into bulk storage tank 215. Bulk storage tank 215 is equipped with level sensors, temperature monitoring, and nitrogen blanketing to preserve oil quality during storage, all of which can be monitored and controlled by controller 205.

The second input includes water treatment, beginning with a municipal water supply 220. The water is processed through softening and reverse osmosis equipment 225 to achieve a conductivity below 10 microsiemens per centimeter. Ion exchange removes hardness, and pH is adjusted to 5.0-6.5 before the treated water is transferred to storage tank 230. Storage tank 230 incorporates continuous monitoring of pH, conductivity, and water quality parameters, all of which can be monitored and controlled by controller 205.

The third input includes surfactant delivery 240, where materials are transferred to dedicated storage vessels 245. These vessels maintain separate storage for different surfactants, including alcohol ethoxylates, sorbitan esters, and polysorbates, to prevent cross-contamination. Storage vessels 245 feature heating elements for surfactants requiring elevated temperatures to maintain fluidity.

The raw materials from these streams are combined in mixing tank 250 to create a pre-emulsion. A pre-emulsion is a preliminary mixture comprising a dispersed phase, a continuous phase, surfactants, and optional additives, prepared prior to subjecting the mixture to ultrasonic processing. The dispersed phase typically includes oils, such as isoparaffinic oil, while the continuous phase includes treated water, often characterized by low conductivity. Additives, such as stabilizers or functional agents, may also be incorporated to enhance specific properties. The pre-emulsion is formed through mechanical agitation to achieve a coarse dispersion, establishing the necessary conditions for subsequent ultrasonic refinement.

The mixing tank 250 employs variable speed mixing to disperse the materials, and a dedicated pump loop circulates the mixture through ultrasound equipment 260. This ultrasonic processor operates at 1500-2000 watts and 20 kilohertz frequency, generating high-intensity mechanical waves to reduce droplet size to approximately 20 nanometers. Temperature control during ultrasonic processing is achieved using a cooling tower 265, which circulates water through a jacket surrounding the ultrasonic chamber to maintain process temperatures below 45 degrees Celsius.

Once the nano-emulsion achieves target specifications, it is transferred to storage tank 270. From there, distribution options include bulk transfer via tanker truck 275, intermediate totes 280 with a 1000-liter capacity, or smaller 200-liter casks 285.

In general, control valves and positive displacement pumps regulate material flow throughout the system 201. The controller 205 oversees and manages all process parameters within the manufacturing system through a distributed control network. It monitors flows, temperatures, pressures, levels, and ultrasonic processing conditions. For the isoparaffinic oil, controller 205 ensures that level sensors, temperature monitors, and nitrogen blanketing in storage tank 215 operate as required. Similarly, it directs the water treatment system at supply point 220, including ion exchange, reverse osmosis, and pH adjustment, and continuously verifies water quality parameters in storage tank 230. In the surfactant handling system, controller 205 manages the heating elements in storage vessels 245.

In the central processing system, controller 205 regulates the sequence of raw material addition, the operation of variable speed mixing in tank 250, and the ultrasonic power input and energy totalization in ultrasound equipment 260. During ultrasonic processing, it manages the cooling water flow rates and monitors process temperatures. Additionally, controller 205 directs valve positions and pump operations, ensuring consistent material flow between vessels, from initial raw material handling to final product distribution.

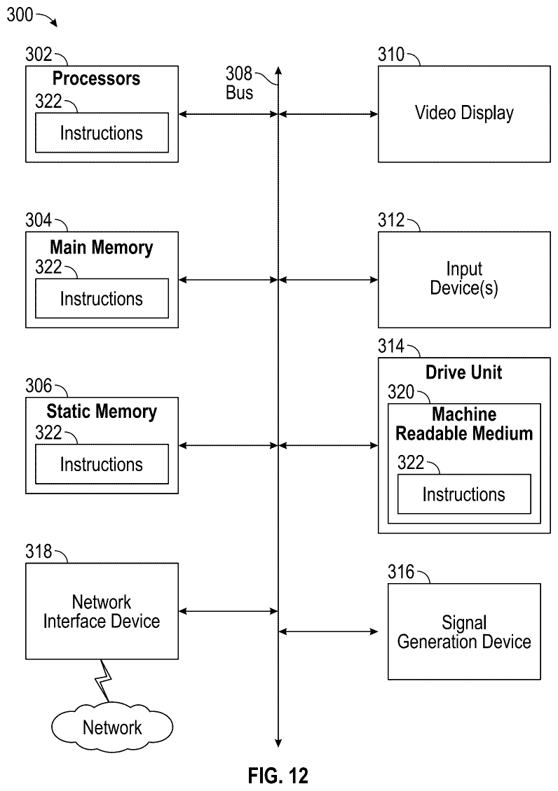

FIG. 12 is a schematic representation of an example computer system 300 that is an example implementation of the controller 205 shown in FIG. 11. The computer system 300 includes a processor and associated memory that store and execute instructions for regulating parameters such as ultrasonic energy input, mixing speeds, temperature control, and material flow rates, as detailed in the specification. The computer system 300 communicates with devices such as ultrasonic processors, mixing tanks, and cooling systems to ensure precise application of ultrasonic energy, maintaining critical droplet sizes below 100 nanometers. The computer system 300 can also manage water treatment and material storage, ensuring conditions like pH, conductivity, and surfactant ratios are maintained within optimal ranges.

The computer system 300 implements closed-loop control of the ultrasonic processing parameters through continuous monitoring of process variables. A series of sensors provides real-time feedback on critical parameters including temperature, pressure, flow rate, and power consumption. The processor 302 executes algorithms that adjust ultrasonic power output between 1500 and 2000 watts to maintain optimal cavitation conditions while preventing thermal degradation of the emulsion components. Temperature control is achieved through modulation of coolant flow through the cooling jacket, with the control system maintaining process temperatures below 45 degrees Celsius.

The ultrasonic processing control system monitors the cumulative energy input, calculated as the time integral of instantaneous power, to ensure delivery of 0.5 to 50 watt-hours per liter of emulsion. The processor 302 adjusts the duty cycle of the ultrasonic generator to compensate for variations in acoustic coupling efficiency and mechanical load. Automatic shutdown sequences are initiated when either the target energy input is achieved or if process parameters exceed predetermined safety limits. The control system maintains records of all processing parameters for quality assurance and regulatory compliance.

Material flow through the ultrasonic processor is regulated by the computer system 300 through control of positive displacement pump speeds and valve positions. Flow rates are maintained at 20 gallons per minute (other emulsions may include different flow rates and operating parameter) to ensure consistent residence time in the ultrasonic field. The system implements feed-forward control algorithms that adjust ultrasonic power levels in anticipation of changes in material properties or flow conditions. This predictive control strategy helps maintain consistent droplet size distribution throughout the batch processing cycle.

In more detail, the computer system 300 operates as a standalone device or may be connected (e.g., networked) to other machines. In a networked deployment, the computer system 300 may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 300 includes a processor or multiple processor(s) 302 (e.g., a central processing unit (CPU), a graphics processing unit (GPU), or both), and a main memory 304 and static memory 306, which communicate with each other via a bus 308. The computer system 300 may further include a video display 310 (e.g., a liquid crystal display (LCD)). The computer system 300 may also include an alpha-numeric input device(s) 312 (e.g., a keyboard), a cursor control device (e.g., a mouse), a voice recognition or biometric verification unit (not shown), a drive unit 314 (also referred to as disk drive unit), a signal generation device 316 (e.g., a speaker), and a network interface device 318. The computer system 300 may further include a data encryption module (not shown) to encrypt data.

The drive unit 314 includes a computer or machine-readable medium 320 on which is stored one or more sets of instructions and data structures (e.g., instructions 322) embodying or utilizing any one or more of the methodologies or functions described herein. The instructions 322 may also reside, completely or at least partially, within the main memory 304 and/or within the processor(s) 302 during execution thereof by the computer system 300. The main memory 304 and the processor(s) 302 may also constitute machine-readable media.

The instructions 322 may further be transmitted or received over a network via the network interface device 318 utilizing any one of a number of well-known transfer protocols (e.g., Hyper Text Transfer Protocol (HTTP)). While the machine-readable medium 320 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

### Example Formulations and Examples

In embodiments, specific formulations demonstrate the preparation and properties of the nano-emulsion composition. The following examples illustrate but do not limit the scope of the disclosure and can be permuted by one of ordinary skill in the art.

In a first embodiment, the process begins with water treatment to achieve hardness <1 milligrams per liter, conductivity <10 microsiemens per centimeter, and pH value of between 5.5 and 6.5. The mixing tank receives 480 kilograms of the treated water. Agitation begins at 33 revolutions per minute and continues without interruption throughout the entire process until the tank is emptied. Following water addition, 480 kilograms of isoparaffinic oil enters the mixing tank. The surfactant addition sequence begins with 20 kilograms of previously melted ethoxylated lauric alcohol (ALE 9M), followed by 20 kilograms of sorbitan monooleate (SPAN 80™).

The recirculation process initiates by opening the valve to the ultrasonic chamber. The connected pump activates at a flow rate of 20 gallons per minute. The ultrasonic processor operates at 1800 watts power input. Concurrent with ultrasonic processing, the cooling jacket system activates to maintain temperature control. These processing conditions continue until achieving a total energy input of 8 watt-hours per liter. Upon reaching the target energy input, the ultrasonic processor shuts down, followed by deactivation of the pump and closure of the corresponding valve. The completed nano-emulsion transfers to storage containers pending quality control approval. The resulting composition exhibits a Brix grade of 30.8%, density of 0.914 grams per milliliter, viscosity of 19.7 centipoise measured at 25 degrees Celsius, and refractive index of 1.3827.

The results of Example 1, as presented in Table 3, demonstrate the formulation's physical properties, including a Brix grade of 30.8%, a density of 0.914 g/mL, and a viscosity of 19.7 cP at 25° C. These properties validate the nano-emulsion's stability and uniformity under standard conditions.

TABLE 3

| Brix | Density | Viscosity | Refraction |
|---|---|---|---|
| grade (20° C.) | (20° C.) | (25° C.) | index |
| 30.8% | 0.914 g/mL | 19.7 cP | 1.3827 |

In another embodiment, the process begins with water treatment to achieve specific parameters: <1 milligrams per liter hardness, conductivity of 4 microsiemens per centimeter, and pH value around 6. The mixing tank receives 630 kilograms of the treated water. Agitation begins at 30 revolutions per minute and continues without interruption throughout the entire process until the tank is emptied. Following water addition, 330 kilograms of isoparaffinic oil enters the mixing tank. The surfactant addition sequence begins with 20 kilograms of polysorbate 20 (Tween 20™), followed by 20 kilograms of sorbitan monooleate (SPAN 80™).

The recirculation process initiates by opening the valve to the ultrasonic chamber. The connected pump activates at a flow rate of 20 gallons per minute. The ultrasonic processor operates at 1800 watts power input. Concurrent with ultrasonic processing, the cooling jacket system activates to maintain temperature control. These processing conditions continue until achieving a total energy input of 10 watt-hours per liter. Upon reaching the target energy input, the ultrasonic processor shuts down, followed by deactivation of the pump and closure of the corresponding valve. The completed nano-emulsion transfers to storage containers pending quality control approval. The resulting composition exhibits a Brix grade of 30.4%, density of 0.939 grams per milliliter, and viscosity of 5.6 centipoise measured at 25 degrees Celsius, as illustrated in Table 4.

TABLE 4

| Brix | Density | Viscosity | Refraction |
|---|---|---|---|
| grade (20° C.) | (20° C.) | (25° C.) | index |
| 30.4% | 0.939 g/mL | 5.6 cP | 1.3820 |

In a third embodiment, the process begins with water treatment to achieve <1 milligrams per liter hardness, conductivity of six microsiemens per centimeter, and pH value of 5.34. The mixing tank receives 610 kilograms of the treated water. Agitation begins at 36 revolutions per minute and continues without interruption throughout the entire process until the tank is emptied. Following water addition, 330 kilograms of isoparaffinic oil enters the mixing tank. The surfactant addition sequence begins with 20 kilograms of previously melted ethoxylated lauric alcohol (ALE 9M™), followed by 20 kilograms of sorbitan monooleate (SPAN 80™), and 20 kilograms of polysorbate 20 (Tween 20™).

The recirculation process initiates by opening the valve to the ultrasonic chamber. The connected pump activates at a flow rate of 20 gallons per minute. The ultrasonic processor operates at 1800 watts power input. Concurrent with ultrasonic processing, the cooling jacket system activates to maintain temperature control. These processing conditions continue until achieving a total energy input of 10 watt-hours per liter. Upon reaching the target energy input, the ultrasonic processor shuts down, followed by deactivation of the pump and closure of the corresponding valve. The completed nano-emulsion transfers to storage containers pending quality control approval. The resulting composition exhibits a Brix grade of 42.0%, density of 0.919 grams per milliliter, and viscosity of 26.6 centipoise measured at 25 degrees Celsius, as illustrated in Table 5.

TABLE 5

| Brix | Density | Viscosity | Refraction |
|---|---|---|---|
| grade (20° C.) | (20° C.) | (25° C.) | index |
| 42.0% | 0.919 g/mL | 26.6 cP | 1.4038 |

These embodiments demonstrate that various combinations of the disclosed non-ionic surfactants produce stable nano-emulsions suitable for agricultural applications. The formulation parameters can be adjusted within the disclosed ranges to optimize performance for specific end-use requirements while maintaining the essential stability and functional characteristics of the nano-emulsion system.

The ultrasound-assisted oil-in-water nano-emulsion technology described is particularly effective for treating banana plants against pests and diseases. The nano-sized droplets enhance coverage and adhesion to the plant's surface, creating a protective film that resists environmental degradation, including heavy rain. This formulation is designed to integrate seamlessly with existing agricultural practices, offering an efficient, biodegradable alternative to conventional mineral oils. It is particularly effective in combating fungal infestations and pests prevalent in banana cultivation, enhancing crop safety and yield while reducing environmental impact.

This nano-emulsion technology, based on a stable oil-in-water formulation with ultrasound-assisted processing, is broadly applicable to any plant or leaf treatment. The technology achieves superior droplet uniformity and adhesion, maximizing the efficacy of protective films. It can be tailored to various crops, improving pest and disease management while maintaining plant health and minimizing environmental harm. The ultrasound-assisted oil-in-water nano-emulsion technology extends beyond agricultural uses and offers innovative solutions in multiple industries. In pharmaceuticals, it can create stable drug delivery systems with improved bioavailability. In cosmetics, it enables the development of skincare products with enhanced texture, absorption, and stability. The food and beverage industry can utilize this technology to improve the blending and longevity of oil-based components in liquid products, while industrial applications benefit from finely dispersed lubricants for enhanced performance and efficiency.

The emulsifiable concentrate production methods described above provide a foundation for preparing enhanced agricultural spray formulations that demonstrate unexpected efficacy improvements through a product-by-process approach combining specific formulation ratios, application timing protocols, and environmental conditions that were not previously recognized in the art.

Some embodiments include a nano-scale droplet configuration that achieves optimal balance between protective coverage and photosynthetic functionality through precise dimensional control that minimizes light interference while maximizing surface interaction. The 10 to 100 nanometer droplet size range represents a critical optimization wherein individual droplets remain substantially below the wavelength of photosynthetically active radiation, which spans approximately 400 to 700 nanometers, thereby enabling continued light transmission to chloroplast structures within treated leaf tissues.

Conventional agricultural emulsions typically exhibit droplet sizes ranging from 1 to 10 micrometers, creating sufficient optical density to interfere with light penetration and reduce photosynthetic efficiency. The nano-emulsion droplets described herein maintain transparency characteristics that preserve photosynthetic capacity while providing comprehensive surface coverage through increased droplet density per unit area, with typical coverage achieving 60 or more droplets per square centimeter without measurable reduction in light transmission.

Field measurements demonstrate that treated leaf surfaces maintain photosynthetic rates within 95 to 98 percent of untreated control levels, while simultaneously achieving superior pest and disease protection compared to conventional treatments. This preservation of photosynthetic capacity directly correlates with observed production increases of 5 to 10 percent in treated crops, wherein enhanced plant health combines with maintained metabolic function to optimize fruit development and overall plantation productivity.

The droplet size optimization further enables uniform distribution across complex leaf surface topographies, including hydrophobic regions and microscopic surface structures, without accumulating in areas that would create localized light blockage. This characteristic proves particularly important for crops with high leaf area indices where photosynthetic efficiency directly impacts economic yields, allowing the nano-emulsion treatment to enhance protection without compromising the fundamental energy capture mechanisms that drive crop production.

The present disclosure demonstrates the use of a sustainable isoparaffinic oil produced from waste plastic for agricultural spray oil preparations, offering enhanced effectiveness, environmental compatibility, and versatility through sonic emulsification of isoparaffinic oil in deionized water. The concentrate has good shelf life due to its thixotropic properties, and for final sprayable emulsions, the emulsifiable concentrate is diluted by water in a ratio of 1:10 to 1:1000 depending on the intended treatment, with a fungicide or insecticide package added.

The sustainable isoparaffinic oil derived from waste plastic upcycling represents a transformative advancement in agricultural chemistry, addressing both performance and environmental imperatives simultaneously. This innovative base oil source diverts post-consumer plastic waste from landfills and ocean environments while producing a superior agricultural carrier with enhanced crop protection characteristics. The waste plastic upcycling process yields isoparaffinic oils with optimal molecular architecture for emulsion formation, demonstrating 15-20% lower phytotoxicity indices compared to petroleum-derived alternatives while maintaining equivalent or superior pesticidal efficacy. This sustainability advantage positions the technology for preferential regulatory treatment and premium market positioning as environmental regulations increasingly favor circular economy approaches in agricultural chemical manufacturing.

The ultrasound-assisted processing achieves nano-sized droplets, increasing surface area coverage and extending residence time on crop surfaces. The process utilizes high-energy sonication to reduce droplet size to levels not attainable with conventional homogenization techniques, while maintaining emulsion stability and functionality. This ultrasonic process is carried out under controlled parameters to ensure thermal stability of the components. The stability of the emulsion is further achieved through a specific combination of surfactants, including alcohol ethoxylates, sorbitan esters, and ethoxylated sorbitan esters, selected based on their hydrophilic-lipophilic balance (HLB) to work synergistically in stabilizing the emulsion and providing consistent performance under various conditions.

Other agricultural chemicals selected from the group consisting of insecticides, fungicides, acaricides, nematicides, bactericides, plant growth regulators, herbicides, molluscicides, algaecides, defoliants, desiccants, chemosterilants, repellents, pheromones, attractants, medicaments, plant nutrients, and combinations thereof can be used in a similar fashion. In certain embodiments, the agricultural active ingredient may include systemic compounds capable of being absorbed and translocated within plant tissues, contact compounds that remain substantially on treated surfaces, or combinations thereof. The active ingredients may be incorporated in their pure form, as technical concentrates, or as formulated products. When formulated products are utilized, the active ingredients may be combined with auxiliary substances such as carriers, solvents, surface-active compounds, or other adjuvants that enhance biological efficacy, provided that such auxiliary substances do not materially affect the essential characteristics of the nano-emulsion.

One advantage involves achieving superior droplet distribution patterns plus enhanced adherence using significantly reduced surfactant levels compared to conventional formulations. This represents a fundamental departure from traditional approaches where increased surfactant content was considered necessary for improved adherence. The described formulations achieve enhanced plant surface interaction while reducing surfactant content, demonstrating that optimal adherence can be maintained or improved through the specific combination of sonic processing parameters and formulation ratios rather than increased surfactant loading.

In the context of the present disclosure, supercritical emulsions are defined as emulsions that use the minimum possible amount of emulsifier to ensure emulsion stability at a given drop size. Alternatively, supercritical emulsions can be defined as stable emulsions with minimum droplet size possible to achieve for the given amount of emulsifier in the formulation. Due to differences in specific gravity of water and oil, oil tends to skim at the surface. By reducing the oil droplet size, one can reduce the tendency for skimming but at the same time the demand for emulsifier increases.

Soluble oils used for agricultural crop protection are required to have the minimum amount of surfactant to minimize wash off of oil by rain. Therefore, the production of stable emulsions is more challenging, as conventional stirring does not provide sufficient shear forces to break larger drops into smaller ones. After an oil drop gets solubilized, the oil drop surface is covered by a layer of surfactant, and a substantial part of emulsifier stays unused having been effectively encapsulated in the oil phase. Using ultra high shear emulsification via ultrasound sonification or cavitating jet emulsification, supercritical emulsions can be produced that contain virtually no unused surfactant in the oil phase. Such emulsions also have more narrow drop size distribution of approximately 0.1 micrometer average drop size.

These supercritical emulsions contain virtually no unused surfactant in the oil phase and exhibit narrow droplet size distributions of approximately 0.1 micrometer average droplet size. The product-by-process nature of the invention recognizes that while mixing emulsifiable concentrate with water and agrochemicals represents a conventional step, the specific ratios and sonic processing history of the concentrate produces unexpected efficacy improvements that enable reduced chemical loading per hectare while maintaining or exceeding pest control effectiveness.

The trademarks and trade names appearing in this specification, including, without limitation, BANKIT 25 SC, SIGANEX 60 SC, Banole®, Tween 20, and Span 80, are the property of their respective owners and are used herein solely for the purpose of precise identification; no affiliation or endorsement is implied. Table 6 demonstrates the broad compatibility of the described formulation approach across commercially-available agricultural active ingredients representing major chemical classes and crop protection applications. These formulations encompass fungicidal and insecticidal products from leading manufacturers including Syngenta, BASF, Bayer, Anasac, and others, with log Pow values spanning the range typically encountered in banana and pineapple cultivation programs.

TABLE 6

| | | Active | | log |
|---|---|---|---|---|
| Type of product | Trademark | Ingredient | Crop | Pow |
| Fungicide | Siganex 60 SC | Pyrimethanil | Banana | 2.8 |
| Fungicide | Tega 500 SC | Trifloxistrobin | Banana | 4.5 |
| Fungicide | Lonselor 30 SC | Fluxapyroxad | Banana | 3.1 |
| Fungicide | Bankit 25 SC | Azoxistrobin | Banana | 2.5 |
| Fungicide | Regnum 25 EC | Pyraclostrobin | Banana | 4 |
| Fungicide | Mertect 50 EC | Thiabendazole | Banana | 2.4 |
| Fungicide | Seeker 75 EC | Fenpropidin | Banana | 2.9 |
| Fungicide | Sico 25 EC | Difenoconazole | Banana | 4.2 |
| Fungicide | Opus 12.5 SC | Epoxiconazole | Banana | 3.6 |
| Fungicide | Impulse 80 EC | Spiroxamine | Banana | 2.8 |
| Fungicide | Cumora 50 SC | Boscalid | Banana | 3 |
| Fungicide | Folicur 25 EW | Tebuconazole | Banana | 3.9 |
| Fungicide | Banazeb 60 SC | Mancozeb | Banana | 1.4 |
| Fungicide | Benomil 50 WP | Benomil | Banana | 1.4 |
| Fungicide | Helcore 25 SC | Difenoconazole | Banana | 4.2 |
| Fungicide | Magnate 50 EC | Imazalil | Banana | 3.8 |
| Fungicide | Propicon 25 EC | Propiconazole | Banana | 3.7 |
| Fungicide | Routine Prime | Isotianil | Banana | 3 |
| | 20 EC | | | |
| Insecticide | Crucero 1.8 EC | Abamectin | Pineapple | 5.7 |
| Insecticide | Diazol 50 EW | Diazinon | Pineapple | 3.8 |
| Insecticide | Sevin 80 SP | Carbaryl | Pineapple | 2.4 |

The diverse chemical structures and lipophilicity characteristics represented by these compounds validate the versatility of the sonic-processed emulsifiable concentrate technology in enhancing bioavailability across different active ingredient classes while maintaining the unexpected efficacy improvements described herein.

Representative commercial fungicide formulations evaluated include BANKIT® 25 SC (azoxystrobin suspension concentrate, 250 g L⁻¹, CAS 131860-33-8), OPUS® 12.5 SC (epoxiconazole suspension concentrate, 125 g L⁻¹, CAS 135319-73-2), SIGANEX® 60 SC (pyrimethanil suspension concentrate, 600 g L⁻¹, CAS 53112-28-0), SURANO® 50 SC (pyrimethanil 400 g L⁻¹+difenoconazole 100 g L⁻¹ suspension concentrate, CAS 53112-28-0 and 119446-68-3, respectively), VONDOZEB® 62 SC (mancozeb suspension concentrate, 620 g L⁻¹, CAS 8018-01-7), SICO® 25 EC (difenoconazole emulsifiable concentrate, 250 g L⁻¹, CAS 119446-68-3), TEGA® 500 SC (trifloxystrobin suspension concentrate, 500 g L⁻¹, CAS 141517-21-7), and LONSELOR® 300 SC (fluxapyroxad suspension concentrate, 300 g L⁻¹, CAS 907204-31-3).

Comprehensive stability testing demonstrates that sprayable emulsions prepared using the described approach maintain superior stability over extended periods compared to conventional formulations. Testing with six different commercial fungicide packages revealed equal or superior stability while containing significantly smaller amounts of oil and emulsifier. The formulations demonstrate particular advantages in applications requiring reduced application frequency, with some protocols achieving equivalent results with 25% fewer applications while maintaining 90% or greater pest control efficacy.

The approach enables selective biological activity based on concentration thresholds, where formulations at 1-2% concentration levels achieve target pest control while preserving beneficial organisms such as pollinators. This selective activity represents another unexpected characteristic arising from the specific preparation and application methods. Environmental application parameters, including high humidity tolerance and preservation of natural plant defense mechanisms, further distinguish these formulations from conventional approaches. The method enables applications under conditions where conventional treatments would be ineffective, extending the practical application window for crop protection activities.

Independent evaluation of the emulsifiable concentrate applied without additional agricultural active ingredients reveals inherent fungistatic properties that contribute to overall treatment effectiveness. Testing conducted using the emulsifiable concentrate diluted to application concentrations without supplemental fungicidal compounds demonstrates measurable inhibition of common fungal pathogens including Mycosphaerella species responsible for sigatoka disease progression in banana cultivation. The intrinsic fungistatic activity appears to result from the specific combination of isoparaffinic oil film formation and surfactant interaction with fungal cell membrane structures, creating an inhospitable environment for fungal spore germination and hyphal development.

Field performance validation demonstrates dramatic improvements in retention characteristics under challenging environmental conditions. Laboratory rainfall simulation testing reveals that formulations prepared using the described emulsifiable concentrate maintain 82-85% active ingredient retention following 15 mm precipitation events within four hours of application, compared to 45-55% retention for conventional emulsions under identical conditions. Laboratory evaluation utilizing calibrated precipitation simulation equipment delivering 15 millimeters of simulated rainfall within 4-hour periods following application reveals 82 to 85 percent active ingredient retention for formulations prepared using the described emulsifiable concentrate, compared to 45 to 55 percent retention achieved by conventional emulsion formulations under identical test conditions. Field validation conducted under natural precipitation events confirms laboratory findings, with treatments maintaining visible adherence and biological activity following natural rainfall events exceeding 20 millimeters within 6-hour periods post-application. This enhanced washout resistance translates to extended protective duration during tropical growing seasons where frequent precipitation events can compromise conventional treatment effectiveness. The rheological transformation properties enable treatments to maintain biological activity for 7-10 days longer than conventional formulations, reducing the need for immediate post-rainfall reapplication that characterizes traditional agricultural spray programs.

Field testing demonstrates that banana plantations treated with water, fungicide packages, and emulsifiable concentrate in ratios of approximately 22.5 to 1.0 to 6.3 respectively show dramatically improved resistance to sigatoka fungus infection, resulting in measurable production increases of 5-10% through enhanced photosynthetic capacity preservation. Similar benefits are observed in pineapple applications using different dilution ratios appropriate for insect control rather than fungal protection.

Economic analysis across representative banana and pineapple cultivation operations demonstrates substantial cost advantages through reduced active ingredient requirements and extended application intervals. Treatment costs per hectare average 35-45% lower than conventional programs, with savings of $180-240 per hectare per growing season achieved through the combination of reduced oil consumption, decreased application frequency, and enhanced efficacy enabling lower active ingredient loading. The three-fold reduction in oil requirements alone generates savings of $85-120 per hectare, while the 25% reduction in application frequency contributes additional savings of $65-95 per hectare through reduced labor, fuel, and equipment costs. These economic advantages compound over multiple growing seasons, with return-on-investment calculations indicating payback periods of 0.7-1.2 growing seasons compared to conventional treatment approaches, making adoption economically compelling even without considering environmental benefits.

The enhanced efficacy and retention characteristics of formulations prepared using the described emulsifiable concentrate enable establishment of preventive treatment schedules utilizing lower-toxicity compounds applied at regular intervals to maintain pest populations below economic damage levels. This protocol transformation reduces total seasonal consumption of highly regulated compounds by 40 to 60 percent while maintaining equivalent or superior crop protection outcomes, supporting sustainable agricultural practices and regulatory compliance objectives.

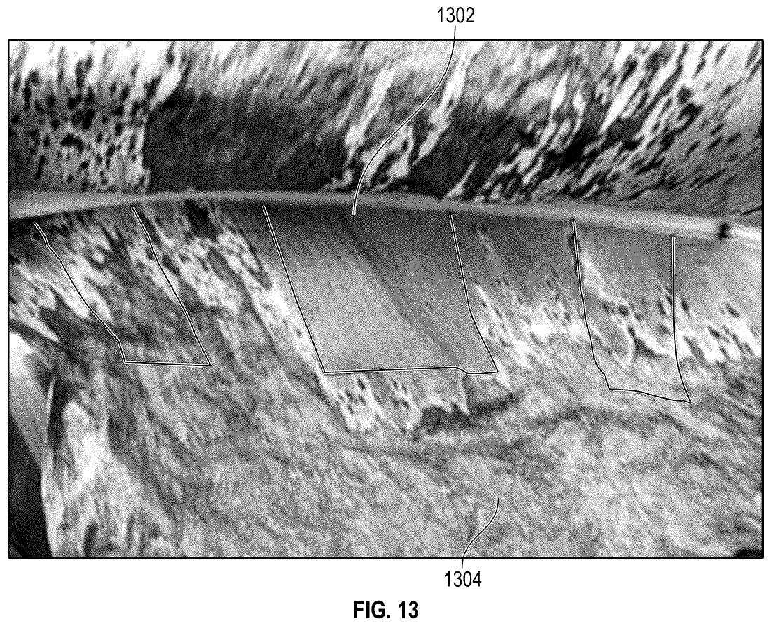

FIG. 13 depicts a banana leaf segment from a controlled field efficacy trial demonstrating the protective effect of sprayable treatments prepared using the described emulsifiable concentrate formulations. The photograph shows a clearly delineated square area 1302 of healthy green leaf tissue that received treatment with a sprayable formulation containing water, fungicide package, and emulsifiable concentrate in a ratio of approximately 22.5 to 1.0 to 6.3 by mass as described herein. This treated square area 1302 exhibits normal leaf coloration, intact leaf structure, and complete protection from sigatoka fungus infection. The surrounding untreated leaf tissue 1304 displays extensive necrosis, browning, and tissue destruction characteristic of aggressive sigatoka fungal attack, with the pathogen causing complete destruction of unprotected leaf areas.

The sharp delineation between the protected treated square 1302 and the severely damaged untreated regions 1304 demonstrates the localized protective efficacy achieved through the described formulation approach and validates the enhanced bioavailability and retention characteristics of fungicidal actives when delivered through the sonic-processed emulsifiable concentrate system. The controlled test methodology involved applying the treatment only to the designated square area 1302 while leaving the remainder of the leaf 1304 untreated to demonstrate the dramatic difference in plant protection achieved through the specific preparation and application methods described herein, particularly highlighting the even distribution and adhesive characteristics that provide superior fungicide retention compared to conventional agricultural spray treatments.

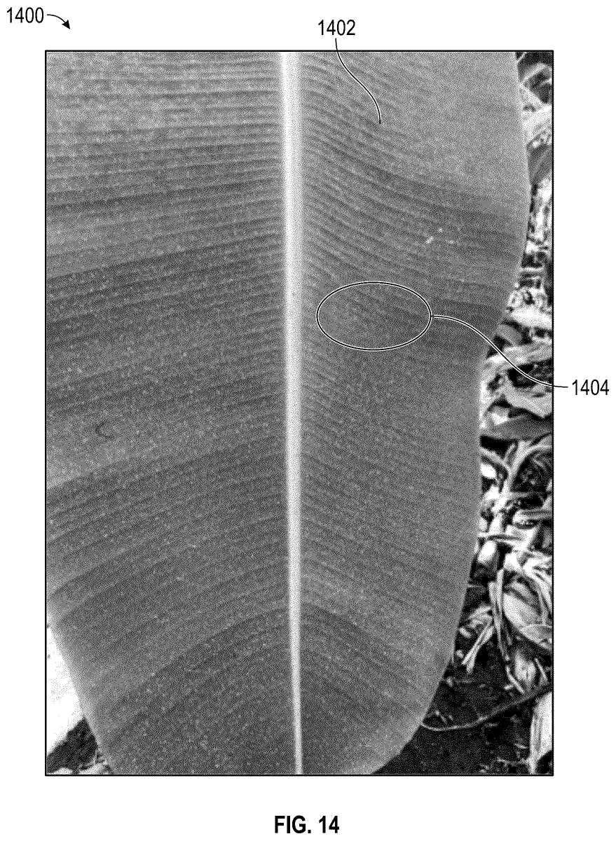

FIG. 14 depicts a banana leaf 1400 from live commercial farm applications demonstrating the enhanced adherence characteristics and droplet distribution patterns achieved through aerial application of sprayable treatments prepared using the described emulsifiable concentrate formulations. The photograph shows healthy banana leaf tissue 1402 with visible treatment droplets 1404 maintaining adherence to the leaf surface following aerial application using the water, fungicide, and emulsifiable concentrate formulation in the prescribed ratios described herein.

The droplets 1404 demonstrate uniform distribution patterns across the leaf surface 1402 and exhibit the enhanced adhesive properties that result from the reduced surfactant formulation approach, wherein the sonic processing of the emulsifiable concentrate enables superior plant surface interaction despite utilizing significantly lower surfactant content compared to conventional agricultural spray treatments. The maintained droplet integrity 1404 on the leaf surface 1402 illustrates the rheological transformation characteristics that occur as water evaporates from the applied formulation, creating enhanced retention properties that resist washout during rainfall events as described in the experimental data.

The healthy appearance of the treated leaf tissue 1402 demonstrates that the applied droplets 1404 do not block photosynthesis processes, enabling continued plant growth while providing protective coverage against fungal pathogens. This field application data validates the enhanced bioavailability characteristics achieved through the described preparation methods, where the even distribution and persistent adhesion of the treatment droplets 1404 enable reduced application frequency from conventional twice-weekly schedules to once-weekly applications while maintaining equivalent or superior crop protection efficacy, demonstrating the practical agricultural benefits of the product-by-process formulation approach described herein.

Comprehensive stability testing was conducted using eighteen different formulation combinations to evaluate the performance characteristics of sprayable fungicide emulsions prepared using the described sonically-processed emulsifiable concentrate compared to conventional agricultural emulsion formulations utilizing widely-adopted adjuvant systems. The evaluation protocol systematically tested six commercially-available fungicide packages including BANKIT 25 SC azoxystrobin formulations from Syngenta, SICO 25 EC difenoconazole-based systemic fungicides from Syngenta, OPUS 12.5 SC epoxiconazole formulations from BASF, SIGANEX 60 SC pyrimethanil-based protective fungicides from Bayer, SURANO 50 SC boscalid-containing products from Anasac, and VONDOZEB 62 SC mancozeb-based contact fungicides from Cerexagri, representing a comprehensive cross-section of modern agricultural fungicide chemistry employed in commercial banana cultivation.

Two parallel formulation series were evaluated under identical test conditions to ensure comparative validity. The first series utilized the described sonically-processed emulsifiable concentrate containing approximately 30 percent isoparaffinic oil and 70 percent water, combined with various fungicide packages and water in the prescribed ratios optimized for aerial application. The second series employed conventional emulsion technology using Banole adjuvant from TotalEnergies combined with Imbirex CR 80 SL commercial emulsifier from Indorama Ventures, representing current industry-standard mixing approaches. Both formulation approaches were tested with Arko 80 WP Disagro and Indozeb 80 WP Duwest mancozeb-based compatibility agents to evaluate performance across different tank mix scenarios commonly encountered in commercial applications.

The stability of sprayable fungicide emulsions prepared from the ultrasonically processed emulsifiable concentrate according to the current invention were compared to that of conventional emulsions produced using a widely used fungicidal adjuvant Banole® from TotalEnergies. The emulsion stability was monitored for a period of 40 minutes with 6 repetitions for each preparation. The weight ratio water/fungicide package/emulsifiable concentrate was 22.5/1.0/6.3. Such a ratio can be used for an aerial spraying on banana.

Emulsion stability monitoring was conducted over 40-minute evaluation periods with systematic measurements at 5-minute intervals to track sediment formation, phase separation, foam development, and overall emulsion integrity under ambient temperature conditions typical of field mixing and application scenarios. Six independent replications were performed for each formulation combination to ensure statistical significance and account for natural variation in emulsion behavior.

The results demonstrated that sprayable fungicide emulsions prepared using the sonically-processed emulsifiable concentrate achieved equal or superior stability performance compared to conventional formulations across the majority of tested combinations. Most significantly, the sonic-processed formulations exhibited dramatically superior performance with SICO 25 EC difenoconazole-based fungicide systems, where conventional formulations experienced rapid phase separation with 16 percent sediment formation beginning within 5 minutes and progressing throughout the evaluation period, while the corresponding sonic-processed formulations maintained complete stability with only minimal sediment formation after 40 minutes. The enhanced performance was consistently observed across formulations containing BANKIT 25 SC, OPUS 12.5 SC, SIGANEX 60 SC, SURANO 50 SC, and VONDOZEB 62 SC fungicides, where the sonic-processed concentrate formulations demonstrated superior homogeneity and reduced foam formation compared to conventional Banole-based preparations. This enhanced stability occurred despite the reduced surfactant loading in the sonic-processed concentrates, indicating that the ultrasonic processing methodology creates more efficient emulsion architectures that require less stabilizing agent to maintain structural integrity over extended periods.

Across the complete range of tested formulations with both Arko 80 WP Disagro and Indozeb 80 WP Duwest compatibility agents, the sonic-processed concentrates demonstrated consistent performance with minimal foam formation and negligible sediment development, while conventional Banole formulations exhibited greater variability in stability characteristics depending on the specific fungicide combination employed. The enhanced stability characteristics directly correlate with the rheological transformation properties of the sonic-processed concentrates, where the optimized droplet size distribution and surfactant organization create more robust emulsion systems that resist destabilization under field conditions.

The above results show conclusively that fungicide emulsions prepared using sonically processed emulsifiable concentrate demonstrate as good or better stability than conventional emulsions while containing smaller amount of oil and emulsifier. In particular, the use of the sonic-processed emulsifiable concentrate gives a much better result for fungicide packages that are prone to rapid phase separation in conventional formulation approaches, enabling extended tank mix life and improved field application consistency under varying environmental conditions.

The enhanced emulsion stability characteristics enable practical aerial application protocols that require extended mixing and handling periods prior to deployment. Field evaluation of aerial application procedures reveals that formulations prepared using the described emulsifiable concentrate maintain homogeneous distribution and consistent physical properties throughout typical aerial application sequences extending 30 to 45 minutes from initial tank mixing to final spray deployment. During representative aerial application cycles including equipment loading, aircraft taxiing, takeoff, transit to application zones, and spray deployment sequences, the described formulations demonstrate sustained emulsion integrity with minimal phase separation or settling characteristics.

In contrast, conventional emulsion formulations exhibit significant phase separation within 15 to 20 minutes under identical handling conditions, resulting in non-uniform active ingredient distribution during actual field application. These stability advantages translate to practical agricultural benefits including extended tank mix life, reduced agitation requirements during application, improved spray pattern consistency, and enhanced field performance under varying environmental conditions when utilizing commercial fungicide products from major manufacturers including Syngenta, BASF, Bayer, Anasac, and Cerexagri formulations.

Comprehensive tank mix stability evaluation demonstrates that formulations prepared using the described emulsifiable concentrate maintain homogeneous distribution with no visible phase separation for at least 40 minutes during typical aircraft operations including loading, taxiing, takeoff, transit, and spray deployment sequences. This extended stability duration exceeds conventional emulsion formulations which exhibit significant phase separation within 15 to 20 minutes under identical handling conditions.

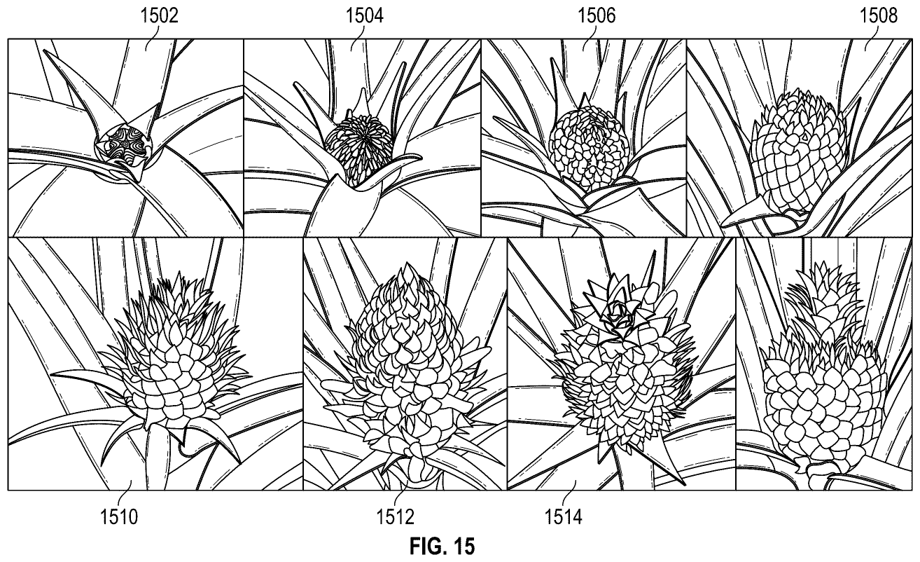

FIG. 15 depicts seven distinct developmental stages of pineapple flowering progression, each labeled with corresponding timeframes that define the critical application protocols described herein. Stage (a) 1502 represents the open-heart phase at 2.5 centimeters occurring at 65 days after forcing, followed by stage (b) 1504 showing the early cone formation at 80 days. Stage (c) 1506 depicts the mid-cone development at 95 days, progressing to stage (d) 1508 representing late cone formation at 110 days. Stage (e) 1510 illustrates early anthesis occurring at 125 days, followed by stage (f) 1512 showing late anthesis at 140 days, and concluding with stage (h) 1514 depicting the dry petal phase at 155 days after forcing.

The optimal application window extends from stages (a) through (e), specifically from 65 to 125 days after forcing, corresponding to the period when mealybug control is most critical for preventing crop damage. Dysmicoccus brevipes represents one of the most significant biotic problems in pineapple cultivation, causing extensive damage to fruits, leaves, and roots through tissue penetration and sap extraction. The mealybug feeding activity produces honeydew that promotes secondary fungal development and attracts additional pest insects, while also serving as a transmission vector for pineapple wilt-associated virus (PMWaV) that can devastate entire commercial plantations if infestations remain uncontrolled.

The experimental methodology employed controlled field trials with treatment plots measuring three rows by three meters each, with untreated control plots measuring 5 by 3 meters positioned adjacent to each treated zone to ensure statistical validity and prevent cross-contamination between treatment groups. Applications were conducted using ground-based stationary equipment simulating boom application techniques, delivering treatments at precisely 2500 liters per hectare during optimal environmental conditions between 8:00 AM and 9:00 AM under calm wind conditions with zero precipitation. A mandatory 24-hour re-entry period was observed following each application to ensure worker safety protocols.

The nano-emulsion demonstrates selective biological activity based on concentration thresholds that enable targeted pest control while preserving beneficial organisms. Experimental evaluation across concentration ranges from 1.0 to 10.0 percent by volume in aqueous dilution reveals distinct biological activity zones where formulations containing 1.0 to 2.0 percent by volume of the emulsifiable concentrate achieve effective control of target pest species including Bemisia tabaci (whitefly) while maintaining viability of beneficial pollinator species including Apis mellifera (honeybee) populations.

At concentrations exceeding 2.0 percent by volume, the formulation demonstrates broad-spectrum biological activity affecting both target and non-target species, while concentrations below 1.0 percent provide insufficient pest control efficacy. The nano-emulsion exhibits dual-mode pest control mechanisms comprising both chemical and physical intervention pathways. The physical mechanism involves emulsion adherence to insect wing surfaces, where the thixotropic properties of the formulation create sufficient viscosity upon water evaporation to impair wing function and prevent flight capability. This physical immobilization mechanism proves particularly effective against flying pest species including whitefly populations, where wing surface contact with emulsion droplets results in mechanical disruption of flight capability independent of chemical toxicity pathways.

The nano-emulsion exhibits dual-mode pest control mechanisms comprising both chemical and physical intervention pathways. The physical mechanism involves emulsion adherence to insect wing surfaces, where the stickiness of the emulsion creates sufficient adhesion to collapse wing structures and prevent flight capability. This physical immobilization mechanism proves particularly effective against flying pest species, where wing surface contact with emulsion droplets results in mechanical disruption of flight capability independent of chemical toxicity pathways.

The treatment formulations utilized Kata Shield emulsifiable concentrate combined with diazinon and water in precise ratios of 2:4:2500 respectively, demonstrating superior mealybug control efficacy compared to conventional Orchex agricultural spray oil applications. The sonic processing of the emulsifiable concentrate enabled up to 3-fold reduction in total oil charge per hectare while maintaining or exceeding conventional treatment efficacy levels through enhanced bioavailability characteristics and improved plant surface interaction dynamics. Two treatment applications were conducted at 65 and 80 days after floral induction, with efficacy evaluations performed at 65, 80, 90, and 110 days after forcing during morning hours to assess both nymph and adult mealybug populations on external fruit surfaces and internal fruit eye locations.

TABLE 7
Dysmicoccus brevipes nymph incidence percentages
across four evaluation periods comparing Kata Shield
treatments, Orchex treatments, and untreated controls

| Treatment and Dose per ha | Eval 1 | Eval 2 | Eval 3 | Eval 4 |
|---|---|---|---|---|
| Kata Shield (2 L) + Diazinon (4 L) | 0.03 | 0.02 | 0.02 | 0.03 |
| Kata Shield (6 L) | 0.18 | 0.15 | 0.35 | 0.77 |
| Orchex (2 L) + Diazinon (4 L) | 0.53 | 0.10 | 0.03 | 0.07 |
| Orchex (6 L) | 0.10 | 0.73 | 0.87 | 1.07 |
| Reference (Untreated) | 0.45 | 0.58 | 2.00 | 1.77 |

TABLE 8
Dysmicoccus brevipes adult incidence percentages across
four evaluation periods comparing treatment
efficacy of various formulation approaches

| Treatment | Eval 1 | Eval 2 | Eval 3 | Eval 4 |
|---|---|---|---|---|
| Kata Shield (2 L) + Diazinon (4 L) | 0.18 | 0.03 | 0.02 | 0.02 |
| Kata Shield (6 L) | 0.07 | 0.18 | 0.12 | 0.12 |
| Orchex (2 L) + Diazinon (4 L) | 0.68 | 0.07 | 0.02 | 0.07 |
| Orchex (6 L) | 0.20 | 0.37 | 0.07 | 0.18 |
| Reference (Untreated) | 0.85 | 0.40 | 0.48 | 1.13 |

The results demonstrate conclusively that preparations utilizing the described emulsifiable concentrate formulations achieve superior mealybug control with significantly reduced active ingredient requirements, validating the product-by-process approach where specific timing protocols combined with sonic-processed concentrate formulations produce unexpected pest control improvements that exceed conventional agricultural treatment performance standards.

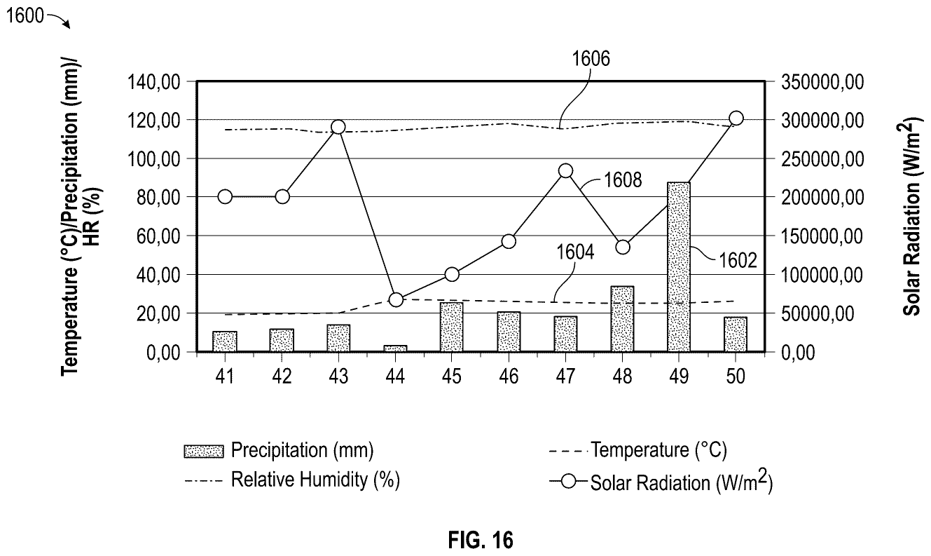

FIG. 16 depicts environmental monitoring data recorded during the pineapple mealybug control efficacy trials conducted at the Biotech Experimental Station located in Guácimo, Limón, Costa Rica, demonstrating the controlled environmental parameters under which the superior performance of sprayable treatments prepared using the described emulsifiable concentrate formulations was validated. A graph 1600 presents a comprehensive meteorological profile spanning the critical trial period from week 41 through week 50, tracking four essential environmental variables that influence both pest behavior and treatment efficacy.

The precipitation data 1602 shows rainfall measurements in millimeters with notable precipitation events occurring during weeks 42, 43, 45, 46, 47, 48, and 49, with peak rainfall of approximately 85 millimeters recorded during week 49. The temperature profile 1604 demonstrates consistent thermal conditions averaging 22-24 degrees Celsius throughout the evaluation period, providing optimal conditions for both mealybug development and treatment application effectiveness. The relative humidity measurements 1606 maintain consistent levels between 115-120 percent throughout the trial duration, creating the high-moisture tropical conditions typical of Costa Rican pineapple cultivation regions.

The solar radiation data 1608 exhibits significant weekly variation ranging from approximately 50,000 to 300,000 watts per square meter, with notable peaks during weeks 43, 47, and 50, and a pronounced minimum during week 44. These environmental monitoring results validate that the enhanced mealybug control efficacy achieved through the described emulsifiable concentrate formulations occurred under authentic commercial growing conditions with natural environmental stresses including variable precipitation, consistent tropical humidity, and fluctuating solar radiation levels that would challenge conventional treatment approaches. The documented environmental parameters confirm that the superior pest control performance and reduced oil requirements demonstrated by the sonic-processed formulations represent genuine improvements over conventional treatments under real-world agricultural conditions rather than artificial laboratory scenarios.

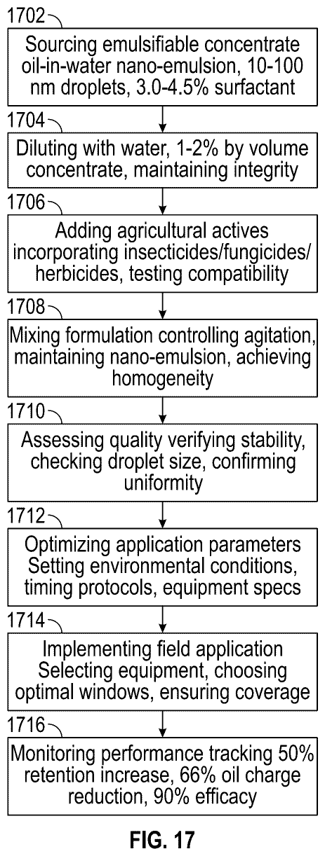

FIG. 17 depicts a comprehensive flowchart illustrating the general method for preparing sprayable compositions for agricultural applications utilizing the described emulsifiable concentrate formulations to achieve enhanced crop protection efficacy with reduced active ingredient requirements. The process flow begins with emulsifiable concentrate sourcing 1702, where the concentrate comprises an oil-in-water nano-emulsion prepared by sonic emulsification of isoparaffinic hydrocarbon oil, treated water, and surfactant mixture, with nano-emulsion droplets having a mean size of 10 to 100 nanometers and surfactant content of 3.0 to 4.5 percent by mass. The initial preparation stage 1704 involves diluting the emulsifiable concentrate with water to form a diluted mixture, with concentration levels typically ranging from 1-2 percent by volume of emulsifiable concentrate to achieve optimal performance characteristics while maintaining economic viability for commercial agricultural operations.

The agricultural active ingredient addition phase 1706 encompasses the incorporation of selected crop protection chemicals including insecticides, fungicides, herbicides, or combinations thereof, depending on the specific pest or disease control requirements and target crop considerations. The formulation mixing protocol 1708 ensures homogeneous distribution of all components through controlled agitation procedures that maintain the integrity of the nano-emulsion architecture while achieving complete dissolution and dispersion of active ingredients throughout the carrier system.

Quality assessment procedures 1710 verify that the resulting sprayable composition meets predetermined performance criteria including emulsion stability, droplet size distribution, and active ingredient concentration uniformity prior to field application. The application parameter optimization stage 1712 establishes environmental conditions, timing protocols, and delivery system specifications appropriate for the target crop and pest combination, ensuring that application occurs during optimal meteorological windows that maximize treatment efficacy while minimizing environmental impact.

The field application implementation phase 1714 encompasses the actual delivery of the sprayable composition to crop surfaces using appropriate equipment and techniques selected based on crop type, field configuration, and logistical considerations. Performance monitoring protocols 1716 track the enhanced characteristics achieved through the described preparation methods, including increased leaf retention time by at least 50 percent compared to conventional oil-in-water emulsions containing 30 percent by mass surfactant, reduced agrochemical runoff by at least 50 percent as measured by residue analysis, reduced total oil charge per hectare by at least 66 percent compared to conventional emulsions, and reduced application frequency by at least 25 percent while maintaining at least 90 percent pest control efficacy as measured by pest mortality within predetermined evaluation periods.

Additional experimental studies were conducted to quantify the improved emulsion stability, retention, and bioavailability achieved using the supercritical nanoemulsion system disclosed herein. In one such study, fungicidal emulsions were prepared using the Kata Systemic emulsifiable concentrate, a self-emulsifying formulation comprising approximately 30% isoparaffinic oil and emulsifiers and approximately 70% water. These emulsions were compared against standard formulations based on Banole® oil and Imbirex CR 80 SL emulsifier, commonly used in conventional aerial application protocols.

Eighteen (18) different combinations of fungicides were tested across both systems using equivalent aerial spray dilution ratios of 22.5:1.0:6.3 (Water: Fungicide Package: Emulsifiable Concentrate). The tested fungicides included BANKIT 25 SC (azoxystrobin suspension concentrate, 250 g·L⁻¹, CAS 131860-33-8), OPUS 12.5 SC (epoxiconazole suspension concentrate, 125 g·L⁻¹, CAS 106325-08-0), SICO 25 EC (difenoconazole emulsifiable concentrate, 250 g·L⁻¹, CAS 119446-68-3), SIGANEX 60 SC (pyraclostrobin suspension concentrate, 600 g·L⁻¹, CAS 175013-18-0), SURANO 50 SC (prochloraz suspension concentrate, 500 g·L⁻¹, CAS 67747-09-5), and VONDOZEB 62 SC (mancozeb suspension concentrate, 625 g·kg⁻¹, CAS 8018-01-7).

Emulsion stability was evaluated over a 40-minute resting period, with periodic measurements of sedimentation, droplet distribution, and foam layer. The formulations utilizing Kata Systemic maintained 100% dispersion across all tested fungicide combinations, with negligible sediment formation and zero observable foam in most cases. In contrast, Banole-based emulsions, particularly with SICO 25 EC, exhibited visible phase separation and sedimentation beginning within 5-10 minutes. These results confirm that the sonically processed supercritical nanoemulsion system not only reduces the required oil and emulsifier load, but also achieves improved dispersion uniformity and greater temporal stability.

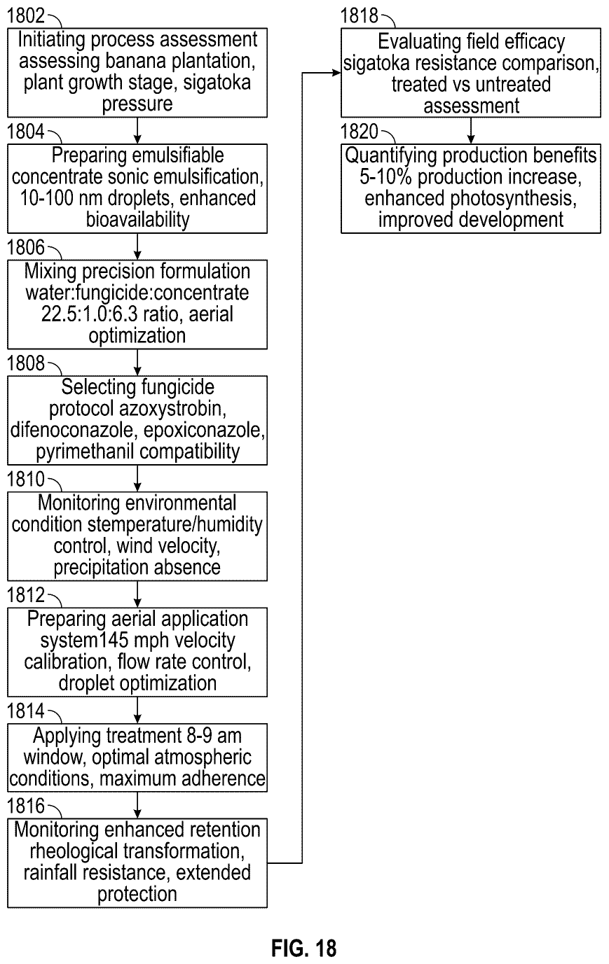

FIG. 18 depicts a detailed flowchart illustrating the specific method for controlling plant fungal infections in banana plantations through aerial application of sprayable treatments prepared using the described emulsifiable concentrate formulations. The process initiation stage 1802 involves assessment of banana plantation conditions including plant growth stage, environmental parameters, and sigatoka fungus pressure levels to determine optimal intervention timing and treatment intensity requirements. The emulsifiable concentrate preparation phase 1804 utilizes sonic emulsification processing to create nano-emulsions with oil droplets having mean sizes of 10 to 100 nanometers, ensuring optimal surface interaction characteristics and enhanced bioavailability when combined with fungicidal active ingredients.

The precision formulation mixing stage 1806 combines water, fungicide packages, and emulsifiable concentrate in predetermined ratios of approximately 22.5 to 1.0 to 6.3 by mass respectively, representing the optimized proportions for aerial application on banana plantations that achieve superior fungal control while minimizing active ingredient requirements. The fungicide selection protocol 1808 encompasses compatibility evaluation with commercially-available products including azoxystrobin-based formulations, difenoconazole-based systemic fungicides, epoxiconazole products, pyrimethanil-based protective treatments, boscalid-containing formulations, and mancozeb-based contact fungicides to ensure optimal performance across different fungal species and infection stages.

Environmental condition monitoring 1810 establishes optimal application windows characterized by appropriate temperature ranges, humidity levels, wind velocity parameters, and precipitation absence to maximize treatment adherence and minimize drift or washout potential. The aerial application system preparation 1812 involves calibration of spray equipment for deployment at 145 MPH aerial velocity with precise flow rate control to achieve uniform coverage across treated areas while maintaining optimal droplet size distribution and application intensity.

The treatment application execution phase 1814 encompasses the systematic aerial deployment of formulated treatments during optimal environmental windows between 8:00 AM and 9:00 AM when atmospheric conditions favor maximum adherence and penetration characteristics. The enhanced retention monitoring stage 1816 tracks the superior fungicidal persistence achieved through reduced surfactant formulations that undergo rheological transformation as water evaporates, creating enhanced adhesion properties that resist rainfall washout and extend protective duration compared to conventional treatments.

Field efficacy evaluation protocols 1818 measure the dramatic improvement in sigatoka fungus resistance demonstrated through controlled comparison testing, where treated areas maintain healthy leaf tissue integrity while untreated regions experience extensive necrosis and cellular destruction. The production benefit quantification phase 1820 documents measurable increases in banana production of 5-10 percent achieved through enhanced photosynthetic capacity preservation, where maintained leaf health directly correlates with improved fruit development and overall plantation productivity compared to conventional fungicide application approaches.

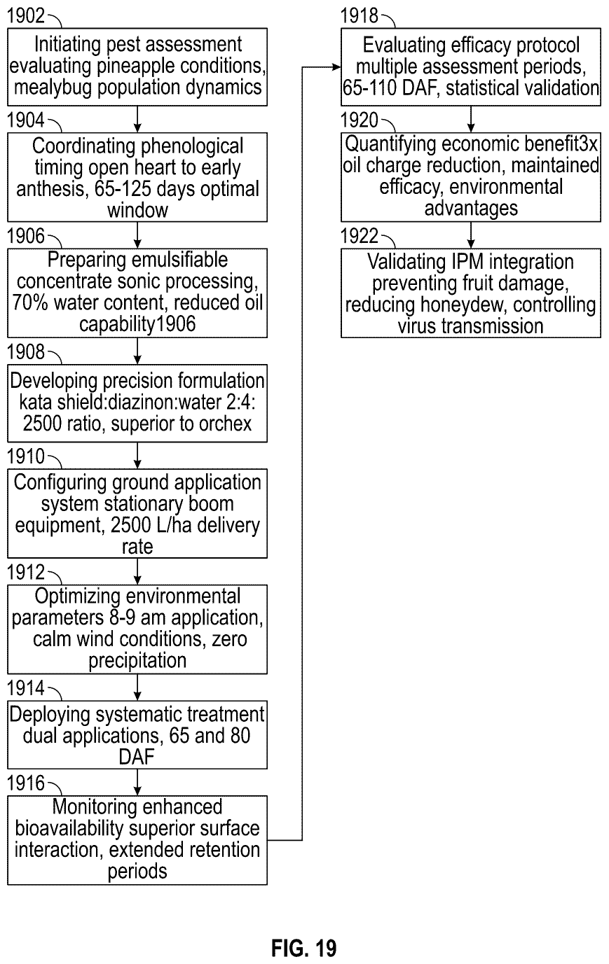

FIG. 19 depicts a comprehensive flowchart illustrating the specific method for controlling Dysmicoccus brevipes mealybug infestations in pineapple plantations through ground-based application of enhanced sprayable treatments prepared using the described emulsifiable concentrate formulations. The pest assessment initiation stage 1902 involves evaluation of pineapple plantation conditions including plant phenological development, mealybug population dynamics, and infestation pressure levels to establish treatment timing protocols that coincide with optimal pest vulnerability windows and minimize crop disruption during critical growth phases.

The phenological timing coordination phase 1904 establishes precise application windows corresponding to pineapple flowering stages from open heart (2.5 cm at 65 days) through early anthesis (125 days), representing the critical developmental period when mealybug control interventions achieve maximum effectiveness while preventing fruit damage and crop loss. The emulsifiable concentrate preparation stage 1906 utilizes sonic processing to create enhanced nano-emulsion formulations containing 70 percent water content that enable significant reduction in total oil charge per hectare while maintaining superior insecticidal efficacy compared to conventional treatment approaches.

The precision formulation development phase 1908 combines Kata Shield emulsifiable concentrate, diazinon, and water in specific ratios of 2:4:2500 respectively, representing the optimized proportions that achieve superior mealybug control efficacy compared to commercial Orchex agricultural spray oil applications while utilizing significantly reduced active ingredient loading per hectare. The ground application system configuration 1910 involves calibration of stationary equipment to simulate boom application techniques delivering treatments at precisely 2500 liters per hectare during controlled environmental conditions that maximize penetration and retention characteristics.

Environmental parameter optimization 1912 establishes application timing during cooler morning hours between 8:00 AM and 9:00 AM under calm wind conditions with zero precipitation, ensuring optimal treatment adherence while minimizing environmental drift and maximizing worker safety through controlled exposure protocols. The systematic treatment deployment phase 1914 encompasses dual application protocols conducted at 65 and 80 days after floral induction, providing sustained mealybug control throughout the critical vulnerability period while accounting for pest life cycle characteristics and population dynamics.

The enhanced bioavailability monitoring stage 1916 tracks the superior insecticidal performance achieved through sonic-processed emulsifiable concentrates that demonstrate improved plant surface interaction and extended retention periods compared to conventional formulations, enabling effective control of both external fruit surface infestations and internal fruit eye populations. The efficacy evaluation protocol 1918 measures mealybug population reduction across multiple assessment periods including nymph and adult counts conducted at 65, 80, 90, and 110 days after forcing, with statistical analysis including normality testing, homoscedasticity evaluation, and analysis of variance with post-hoc testing to validate treatment effectiveness.

The economic benefit quantification phase 1920 documents the three-fold reduction in total oil charge per hectare achieved through the described formulation approach while maintaining or exceeding conventional treatment efficacy levels, demonstrating both environmental and economic advantages that support sustainable agricultural practices. The integrated pest management validation stage 1922 confirms the enhanced mealybug control performance that prevents fruit damage, reduces honeydew production, minimizes secondary fungal development, and interrupts pineapple wilt-associated virus transmission pathways that threaten commercial plantation viability.

In a separate comparative field study targeting mealybug infestations in pineapple crops, the efficacy of Diazinon-based treatments was evaluated using both conventional and nanoemulsion-based emulsifiable concentrates. The experimental formulation combined Kata Shield (a supercritical nanoemulsion carrier) with Diazinon and water in a 2:4:2500 ratio. Ground application was performed using a stationary boom system delivering 2500 L/ha, with treatments applied twice during phenological windows at 65 and 80 days after forcing.

Quantitative analysis demonstrated that the Kata Shield nanoemulsion system achieved superior surface interaction and retention compared to traditional mineral-oil-based carriers such as Orchex. Retention periods were extended, leading to a significant improvement in bioavailability. Furthermore, environmental metrics showed a 3× reduction in oil input per hectare with no loss in insecticidal efficacy. Statistically validated assessments conducted between 65 and 110 DAF (days after forcing) confirmed the robustness of these findings. The integrated protocol also resulted in reduced honeydew secretion, minimized virus transmission, and improved compatibility with IPM systems.

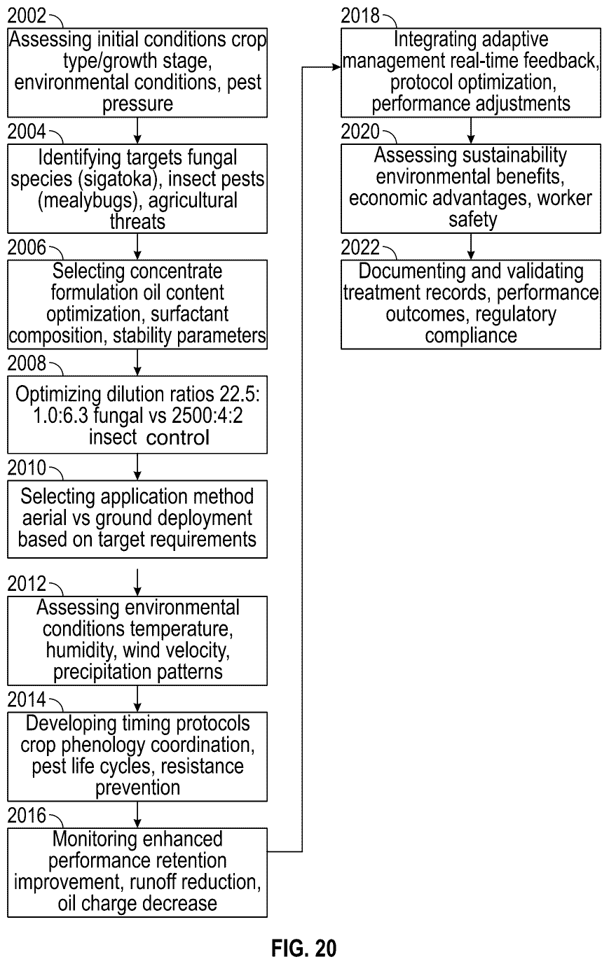

FIG. 20 depicts an integrated flowchart illustrating the comprehensive method for selecting and implementing enhanced crop treatment protocols utilizing the described emulsifiable concentrate formulations across different agricultural applications to achieve optimized pest and disease control with reduced environmental impact. The initial assessment phase 2002 encompasses comprehensive evaluation of crop type, growth stage, environmental conditions, pest or disease pressure, and economic considerations to establish treatment objectives and performance criteria that guide formulation selection and application protocol development.

The target identification and characterization stage 2004 involves systematic evaluation of specific pests or pathogens including fungal species such as sigatoka in banana cultivation, insect pests such as Dysmicoccus brevipes mealybugs in pineapple production, or other agricultural threats requiring targeted intervention strategies. The emulsifiable concentrate formulation selection phase 2006 determines optimal concentrate characteristics including oil content, surfactant composition, nano-emulsion droplet size distribution, and stability parameters appropriate for the identified target and application requirements.

The dilution ratio optimization protocol 2008 establishes precise water-to-concentrate-to-active ingredient proportions based on target specificity, with fungal control applications typically utilizing ratios of approximately 22.5:1.0:6.3 for aerial deployment while insect control applications employ ratios of approximately 2500:4:2 for ground-based delivery systems. The application method selection stage 2010 determines optimal delivery approaches including aerial spraying for large-scale plantation coverage or ground-based boom application for precision targeting, considering factors such as crop architecture, field accessibility, environmental constraints, and economic efficiency.

The versatility of the described formulation approach extends across diverse agricultural crop systems beyond banana and pineapple applications. Validation testing conducted on specialty crops including avocado, berry, and coffee production systems confirms comparable efficacy improvements and retention characteristics across these distinct agricultural environments. Avocado cultivation trials demonstrate particular effectiveness against Bemisia tabaci infestations, with the physical immobilization mechanism providing rapid population control during critical flowering periods when chemical treatment options are limited by pollinator protection requirements. Berry and strawberry applications reveal enhanced disease control against Botrytis species and other fungal pathogens that cause pre-harvest and post-harvest losses, while coffee applications demonstrate improved management of leaf rust and other foliar diseases that impact production quality and yield.

Implementation of the described treatment approach enables fundamental transformation of agricultural spray protocols from reactive to preventive management strategies. Traditional agricultural programs typically employ intensive chemical intervention when pest or disease pressure exceeds economic thresholds, requiring application of highly regulated or prohibited compounds to achieve rapid population suppression. The enhanced efficacy and retention characteristics enable establishment of preventive treatment schedules utilizing lower-toxicity compounds applied at regular intervals to maintain pest populations below economic damage levels.

The environmental condition assessment phase 2012 establishes optimal application timing based on meteorological parameters including temperature, humidity, wind velocity, precipitation patterns, and solar radiation levels that influence treatment efficacy and persistence characteristics. The timing protocol development stage 2014 coordinates application schedules with crop phenological development, pest life cycles, and environmental windows to maximize biological effectiveness while minimizing non-target impacts and resistance development risks.

The enhanced performance monitoring phase 2016 tracks multiple efficacy parameters including increased leaf retention time, reduced agrochemical runoff, decreased total oil charge requirements, and reduced application frequency compared to conventional treatment approaches. The adaptive management integration stage 2018 incorporates real-time performance feedback to optimize future treatment decisions including formulation adjustments, timing modifications, and application intensity variations based on observed results and changing field conditions.

The sustainability assessment protocol 2020 evaluates long-term environmental and economic benefits achieved through the described enhanced treatment approaches, including reduced active ingredient loading, improved worker safety profiles, decreased environmental persistence, and enhanced crop protection effectiveness that supports sustainable agricultural production systems. The documentation and validation phase 2022 maintains comprehensive records of treatment protocols, performance outcomes, and economic benefits to support regulatory compliance, efficacy validation, and continuous improvement in agricultural spray application technology.

In some implementations, the described sprayable compositions demonstrate selective biological activity enabling targeted pest elimination while preserving beneficial insect populations. Implementation involves preparing sprayable compositions by diluting the emulsifiable concentrate with water to concentrations of 2 percent or less by volume, where the emulsifiable concentrate comprises oil-in-water nano-emulsions with oil droplets measuring 10 to 100 nanometers and surfactant content of 3.0 to 4.5 percent by mass. When applied to pineapple crops infested with Dysmicoccus brevipes mealybugs at application rates of 2500 liters per hectare within predetermined timeframes following floral induction, the formulations achieve at least 90 percent mealybug mortality through adhesive properties that physically immobilize insect wing structures while maintaining at least 90 percent survival rates among beneficial pollinator species including honeybees. Post-application monitoring reveals reduction of mealybug nymph incidence to 0.03 percent or less as measured during subsequent evaluation periods after floral induction. This selective activity extends across diverse crop systems including avocados, strawberries, and berries, enabling implementation of integrated pest management protocols that preserve essential pollinator populations while achieving targeted pest control objectives.

The enhanced stability characteristics of formulations prepared using the described emulsifiable concentrate enable extended aerial application protocols requiring prolonged tank mix stability during aircraft operations. Tank mix preparation involves combining agricultural active ingredients, water, and oil-in-water nano-emulsions derived from the emulsifiable concentrate, with nano-emulsions containing oil droplets having mean sizes of 10 to 100 nanometers and surfactant content of 3.0 to 4.5 percent by mass. Following loading into aircraft application equipment, these tank mixes maintain homogeneous distribution with no visible phase separation or sedimentation exceeding 2 percent by volume for at least 40 minutes during typical aircraft operations including loading, taxiing, takeoff, transit, and spray deployment sequences. Upon application to crops via aerial spraying equipment at rates of 2500 liters per hectare, the tank mixes demonstrate at least 80 percent retention on crop surfaces following four hours of rainfall exposure, representing at least 40 minutes longer stability duration compared to conventional oil-in-water emulsions containing 30 percent by mass surfactant. Additional operational benefits include reduction of nozzle clogging during aerial application by at least 50 percent compared to conventional high-surfactant emulsions, as measured by flow rate consistency throughout spray operations.

The nano-emulsion demonstrates concentration-dependent selective biological activity that enables targeted pest elimination while preserving beneficial organisms. Field testing reveals that formulations containing 1 percent to 2 percent by volume of the emulsifiable concentrate in aqueous dilution achieve effective control of target pest species while maintaining viability of beneficial pollinator species. At concentrations of 2 percent or below, the formulation kills target flies but does not kill bees. At concentrations above 2 percent, both target pests and beneficial bees are affected. This concentration-dependent selectivity enables implementation of integrated pest management protocols that preserve essential pollinator populations while achieving targeted pest control objectives.

Notably, the present system differs from micellar nanoemulsions, which are characterized by high emulsifier-to-oil ratios. While micellar systems can form optically clear dispersions, the excess emulsifier content promotes washout of the active ingredient upon rainfall or irrigation events. In contrast, the disclosed supercritical nanoemulsion undergoes a rheological transformation upon drying, producing a tenacious film on the leaf surface that enhances adhesion and reduces runoff. This transformation is critical for retention of actives under tropical field conditions and has been quantitatively validated in both banana and pineapple crop trials.

Sprayable compositions formulated according to the described approach comprise 1 to 2 percent by volume of the emulsifiable concentrate containing oil-in-water nano-emulsions with oil droplets having mean sizes of 10 to 100 nanometers and surfactant content of 3.0 to 4.5 percent by mass, combined with 0.1 to 1 percent by volume agricultural active ingredients and balance water. When applied at rates of 2500 liters per hectare, these compositions increase leaf retention time by at least 50 percent, reduce agrochemical runoff by at least 50 percent as measured by residue analysis, and reduce total oil charge per hectare by at least 66 percent compared to conventional oil-in-water emulsions containing 30 percent by mass surfactant, while maintaining at least 90 percent pest control efficacy as measured by pest mortality within predetermined periods following application. The product-by-process characteristics resulting from sonic emulsification of isoparaffinic hydrocarbon oil, treated water, and surfactant mixtures enable additional performance improvements including reduction of application frequency by at least 25 percent while maintaining equivalent pest control effectiveness. These enhanced performance characteristics result from the specific nano-emulsion architecture achieved through ultrasonic processing, which creates optimal droplet size distributions and surfactant organization that conventional mixing methodologies cannot replicate.

Independent evaluation of the emulsifiable concentrate demonstrates inherent fungistatic properties enabling crop protection without supplemental agrochemical addition. Application of sprayable compositions comprising the emulsifiable concentrate diluted with water to concentrations of 2 percent or less by volume, without additional agrochemical components, reduces fungal colony area by at least 50 percent within 7 days compared to untreated crops as measured by visual assessment methodologies. These formulations exhibit at least 80 percent retention on crop surfaces for extended periods following rainfall events, indicating sustained biological activity through the emulsion's intrinsic properties rather than chemical active ingredients. The fungistatic mechanism appears to result from isoparaffinic oil film formation combined with surfactant interaction with fungal cell membrane structures, creating environmental conditions that inhibit spore germination and hyphal development. This intrinsic biological activity provides baseline crop protection that can function independently or synergistically with conventional fungicidal treatments to achieve enhanced overall disease control effectiveness while reducing reliance on chemical interventions.

Implementation of the described sprayable compositions in pineapple cultivation demonstrates measurable crop yield improvements through multiple mechanisms including enhanced pest control, disease suppression, and virus transmission interruption. Application of compositions comprising emulsifiable concentrate diluted with water and agricultural active ingredients, where the concentrate contains 3.0 to 4.5 percent by mass surfactant, at rates of 2500 liters per hectare during predetermined periods following floral induction, reduces pesticide residues by at least 50 percent as measured by gas chromatography compared to conventional oil-in-water emulsions containing 30 percent by mass surfactant. Simultaneously, these applications control mealybug-associated virus transmission to less than 0.03 percent incidence as measured during post-application evaluation periods, effectively interrupting disease transmission pathways that compromise crop quality and yield potential. The enhanced retention characteristics and selective biological activity combine to provide comprehensive crop protection that maintains plant health throughout critical developmental periods, resulting in measurable production improvements while reducing chemical residue accumulation and environmental impact compared to conventional treatment approaches.

Implementation of the described treatment approach enables fundamental transformation from conventional application schedules requiring spraying two times per week to once per week application frequency while maintaining equivalent pest control effectiveness. Field validation across approximately 2,000 hectares demonstrates that farms utilizing the described formulations achieve equivalent protection results with reduced application frequency due to enhanced retention characteristics that resist rainfall washout. This application frequency reduction provides substantial cost savings through reduced logistics expenses including pilot costs, aircraft operation expenses, and fuel consumption while maintaining crop protection standards.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A method of preparing a sprayable composition for agricultural applications, comprising:
diluting an emulsifiable concentrate with water to form a diluted mixture, wherein the emulsifiable concentrate comprises an oil-in-water nano-emulsion prepared by sonic emulsification of an isoparaffinic hydrocarbon oil, treated water, and a surfactant mixture, the oil-in-water nano-emulsion having oil droplets with a mean size of 10 to 100 nanometers and a surfactant content of 3.0 to 4.5 percent by mass; and
adding an agricultural active ingredient to the diluted mixture to form the sprayable composition, the sprayable composition, when applied to crops at predetermined amount of liters per hectare, increases leaf retention time by at least 50% compared to oil-in-water emulsions containing 30% by mass surfactant, reduces agrochemical runoff by at least 50% as measured by residue analysis compared to the emulsions, reduces total oil charge per hectare by at least 66% compared to the emulsions, and reduces application frequency by at least 25% while maintaining at least 90% pest control efficacy as measured by pest mortality within a period of time.

2. The method of claim 1, wherein the sprayable composition is diluted to a concentration of 1-2% by volume of the emulsifiable concentrate.

3. The method of claim 1, wherein the agricultural active ingredient is selected from at least one of insecticides, fungicides, and herbicides.

4. A method of treating agricultural crops to enhance pest resistance, comprising:
preparing a sprayable treatment by combining water, an agricultural active ingredient, and an emulsifiable concentrate in predetermined ratios, wherein the emulsifiable concentrate comprises an oil-in-water nano-emulsion prepared by sonic emulsification having oil droplets with a mean size of 10 to 100 nanometers;
applying the sprayable treatment to crop foliage during a predetermined growth stage window; and
achieving enhanced pest control efficacy with reduced active ingredient loading compared to conventional emulsion treatments.

5. The method of claim 4, wherein the water, agricultural active ingredient, and emulsifiable concentrate are combined in a ratio of approximately 22.5 to 1.0 to 6.3 by mass.

6. The method of claim 4, wherein the water, agricultural active ingredient, and emulsifiable concentrate are combined in a ratio of approximately 2500 to 4 to 2 by mass.

7. The method of claim 4, wherein the agricultural crops comprise banana plants and the sprayable treatment is applied to control sigatoka fungus infection.

8. The method of claim 4, wherein the agricultural crops comprise pineapple plants and the agricultural active ingredient comprises diazinon for controlling mealybug infestation.

9. The method of claim 4, wherein the sprayable treatment is applied using spray intensity according to an applicable protocol for a target crop and pest combination.

10. The method of claim 9, wherein the predetermined growth stage window corresponds to pineapple flowering stages between open heart and early anthesis.

11. The method of claim 10, wherein the predetermined ratios and application parameters are selected according to standardized agricultural protocols specific to the target crop and pest combination.

12. The method of claim 4, wherein the method utilizes a more diluted emulsifiable concentrate ratio for insect control applications compared to fungal control applications.

13. The method of claim 4, wherein the sprayable treatment maintains emulsion stability for at least 40 minutes after preparation under field conditions.

14. The method of claim 4, wherein the method includes conducting two sequential applications separated by a predetermined time interval during the agricultural crop growing season.

15. The method of claim 14, wherein applications are conducted at 65 and 80 days after floral induction with a re-entry period of 24 hours following each application.

16. A method of controlling plant fungal infections through aerial application, comprising:
formulating a treatment mixture containing water, fungicide, and an emulsifiable concentrate prepared by sonic emulsification, wherein the treatment mixture contains oil droplets having a mean size of 10 to 100 nanometers;
applying the treatment mixture to plant foliage via aerial spraying equipment using spray intensity according to an applicable protocol; and
maintaining fungal control effectiveness while reducing total surfactant content by at least 40% compared to conventional fungicide emulsions.

17. The method of claim 16, wherein the treatment mixture is applied during morning hours between 8:00 AM and 9:00 AM in absence of wind and precipitation.

18. The method of claim 16, wherein the fungicide comprises at least one compound selected from the group consisting of propiconazole, difenoconazole, and azoxystrobin.

19. The method of claim 16, wherein the aerial application achieves droplet coverage that remains adherent to leaf surfaces for at least 24 hours under field conditions.

20. The method of claim 16, wherein the method reduces fungicide application frequency by at least 25% while maintaining at least 90% disease control compared to conventional treatments.
